(19) United States
(12) Patent Application Publication
(10) Pub. No.: US 2014/0325407 A1
(43) Pub. Date: Oct. 30, 2014

(54) COLLECTION, TRACKING AND PRESENTATION OF READING CONTENT

(71) Applicant: MICROSOFT CORPORATION, Redmond, WA (US)

(72) Inventors: Katrika Morris, Issaquah, WA (US); Lauren Javor, Seattle, WA (US); Kami Neumiller, Woodinville, WA (US)

(73) Assignee: Microsoft Corporation, Redmond, WA (US)

(21) Appl. No.: 13/870,975

(22) Filed: Apr. 25, 2013

(51) Int. Cl. G06F 3/0484

(52) U.S. Cl. CPC G06F 3/04842
USPC 715/765

(57) ABSTRACT

Reading material is presented according to a given format. A user can interact with a user input mechanisms to change the format and text the reading material is automatically reflowed to the changed format.

### BACKGROUND

Electronic reading material is currently being made available to users for consumption. For instance, a user of an electronic reading device can access, or download, free reading material or reading material that must be purchased. The user can then read the material at his or her convenience on the electronic reading device.

Reading material, even when in digital form, is often not optimized for individuals with specific or contextual needs. For instance, individuals often have different learning or reading styles. In addition, they may have different amounts of time within which to consume certain types of reading material. Also, individuals who are attempting to learn (and read) in a new language or who have reading disabilities may wish the content to be formatted in a different way than other users.

Some existing electronic reading devices do offer some layout options. However, these options are often very granular. For instance, the user may be able to change the font size, spacing and even margin widths of the reading material. However, this type of individual adjustment can be cumbersome and time consuming for the user.

Some data collection systems are also currently in wide use. For instance, in some systems, data is passively collected by a service while a person is using the service. This data can be used to help target content or advertizing to fit the interests, and demographics of that user. Some social networks, for example, collect large amounts of data about people, such as their interests and their connections within a social graph. However, the users often do not have access to the information, either to view it or to modify it.

The type of collected information may not accurately represent the user. This can occur for a number of reasons. For instance, if the user used a different service previously, the current data (collected by the current service) may only represent a small snapshot of the user's actual history. In addition, if multiple users are using a single account or device, data collected may represent a combination of those multiple users, instead of each individual user. Also, it may happen that the collected information is accurate, but does not represent the user in the way that the user wishes to be publically represented. Because the information is not shared with the user, the user has no ability to modify, or even view, the collected data.

There are currently some services available that collect data and share it with the user. These types of systems often track physical exercise, sleep, money spent, and time spent in various geographic locations. In electronic reading devices, one such service tracks the number of pages that a user turns, the items in a user's library, and the number of books finished by a user. Such a service also allows the user to indicate whether the user's entire profile (as a whole) will be public or private.

The discussion above is merely provided for general background information and is not intended to be used as an aid in determining the scope of the claimed subject matter.

### SUMMARY

Reading material is presented according to a given format. A user can interact with a user input mechanism to change the format and text in the reading material is automatically reflowed to the changed format.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative content management system.

FIGS. 2A and 2B are a flow diagram showing one embodiment of the overall operation of the system shown in FIG. 1.

FIG. 2C is a flow diagram illustrating one embodiment of the operation of a statistics management component.

FIGS. 2D-2G are illustrative user interface displays.

FIG. 3 is a block diagram of one embodiment of a formatting component.

FIG. 3A is a flow diagram illustrating one embodiment of the overall operation of the formatting component shown in FIG. 3.

FIGS. 3B-3H show illustrative user interface displays.

FIG. 4 is a block diagram showing one embodiment of a consumption time manager.

FIG. 4A is a flow diagram illustrating one embodiment of the operation of the consumption time manger shown in FIG. 4.

FIG. 5 is a block diagram illustrating one embodiment of a detail manger.

FIG. 5A is a flow diagram illustrating one embodiment of the operation of the detail manager shown in FIG. 5.

FIGS. 5B-5F are illustrative user interface displays.

FIG. 6 is a flow diagram illustrating one embodiment of the operation of a media manager shown in FIG. 1.

FIG. 6A is one illustrative user interface display.

FIG. 7 is a flow diagram illustrating one embodiment of the operation of a note taking component shown in FIG. 1.

FIGS. 7A-7B are illustrative user interface displays.

FIG. 8 is a flow diagram illustrating one embodiment of the operation of a connection generator shown in FIG. 1.

FIG. 8A is one illustrative user interface display.

FIG. 9 is a flow diagram illustrating one embodiment of an interest calculation component shown in FIG. 1.

FIG. 9A shows one illustrative user interface display.

FIG. 10 is a flow diagram illustrating one embodiment of the operation of a content collection component in making recommendations to a user.

FIG. 11 is a flow diagram illustrating one embodiment of the operation of a social browser shown in FIG. 1.

FIG. 12 shows the content management system of FIG. 1 in various architectures.

FIGS. 13-18 show examples of mobile devices.

FIG. 19 is a block diagram of one illustrative computing environment.

### DETAILED DESCRIPTION

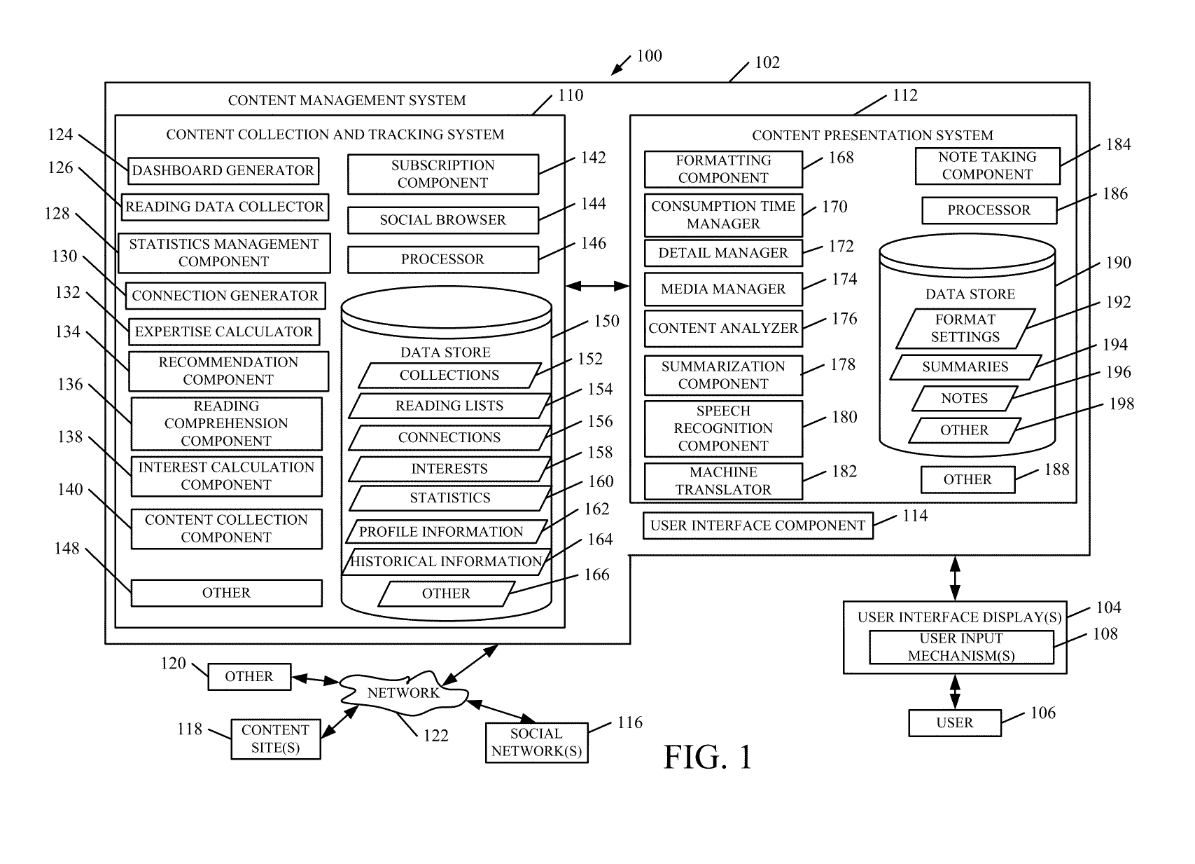

FIG. 1 is a block diagram of an architecture 100 in which content management system 102 is deployed. FIG. 1 shows that content management system 102 is accessed through user interface displays 104 by a user 106. The user interface displays 104 illustratively include user input mechanisms 108 that are displayed for interaction by user 106 in order to manipulate and control content management system 102.

Content management system 102 illustratively includes content collection and tracking system 110, content presentation system 112, and user interface component 114. FIG. 1 shows that content management system 102 can illustratively access social networks 116, content sites 118, and other resources 120 over a network 122. In one embodiment, network 122 is illustratively a wide area network, but it could be a local area network or another type of network as well.

Content collection and tracking system 110 illustratively collects content (such as reading material) that can be consumed by user 106. It also illustratively tracks various statistics and other information for user 106. Further, it generates a dashboard for displaying the information and statistics and presents the dashboard as a user interface display 104 with user input mechanisms 108 so that user 106 can review and modify the statics and other information displayed on or accessible through the dashboard.

Content presentation system 112 presents individual items of content for consumption by user 106. It presents the content according to format settings that are defaulted or set by user 106, and it allows user 106 to perform other operations with respect to the content, such as change the level of detail shown, take notes, change the format settings, etc. Again, user 106 illustratively does this by interacting with user input mechanisms 108 on user interface displays 104, where the content is displayed.

User input mechanisms 108 can take a wide variety of different forms, such as buttons, icons, links, text boxes, dropdown menus, check boxes, etc. In addition, the user input mechanisms can be actuated in a wide variety of different ways as well. For instance, they can be actuated using a point and click device (such as a mouse or track ball), using a soft or hard keyboard or keypad, a thumb pad, a joystick, or other buttons or input mechanisms. Further, if the device on which user interface displays 104 are displayed has a touch sensitive screen, the user input mechanisms 108 can be actuated using touch gestures, such as with a user's finger, a stylus, etc. In addition, if the user device has speech recognition components, the user input mechanisms 108 can be actuated using speech commands.

Content collection and tracking system 110 illustratively includes dashboard generator 124, reading data collector 126, statistics management component 128, connection generator 130, expertise calculator 132, recommendation component 134, reading comprehension component 136, interest calculation component 138, content collection component 140, subscription component 142, social browser 144, and processor 146. Of course, it can also include other components as represented by box 148. In addition, system 110 illustratively includes data store 150. Data store 150, itself, includes collections (or stacks) of reading material 152, reading lists 154, connections 156, user interests 158, statistics 160, profile information 162, historical information 164 and other information 166.

While system 110 is shown with a single data store 150 as part of system 110, it will be noted that data store 150 can be two or more data stores and they can be located either local to or remote from system 110. In addition, some can be local while others are remote.

Processor 146 is illustratively a computer processor with associated memory and timing circuitry (not separately shown). It is illustratively a functional part of system 110 and activated by the other items in system 110 to facilitate their functionality. While a single processor 146 is shown, it should be noted that multiple processors could be used as well, and they could also be part of, or separate from, system 110.

Content presentation system 112 illustratively includes formatting component 168, consumption manager 170, detail manger 172, media manager 174, content analyzer 176, summarization component 178, speech recognition component 180, machine translator 182, note taking component 184, and processor 186. Of course, system 112 can include other components 188 as well. FIG. 1 also shows that system 112 includes data store 190, which, itself, includes format settings 192, summaries 194, notes 196, and other information 198.

Processor 186 is illustratively a computer processor with associated memory and timing circuitry (not separately shown). It is a functional part of system 112 and is activated by, and facilitates the functionality of, other items in system 112.

In addition, data store 190 is shown as a single data store, and it is shown as part of system 112. However, it should be noted that it can be multiple different data stores and they can be local to system 112, remote from system 112 (and accessible by system 112), or some can be local while others are remote.

User interface component 114 illustratively generates user interface displays 104 for display to user 106. Component 114 can generate the user interface displays 104 itself, or under control of other items in content management system 102.

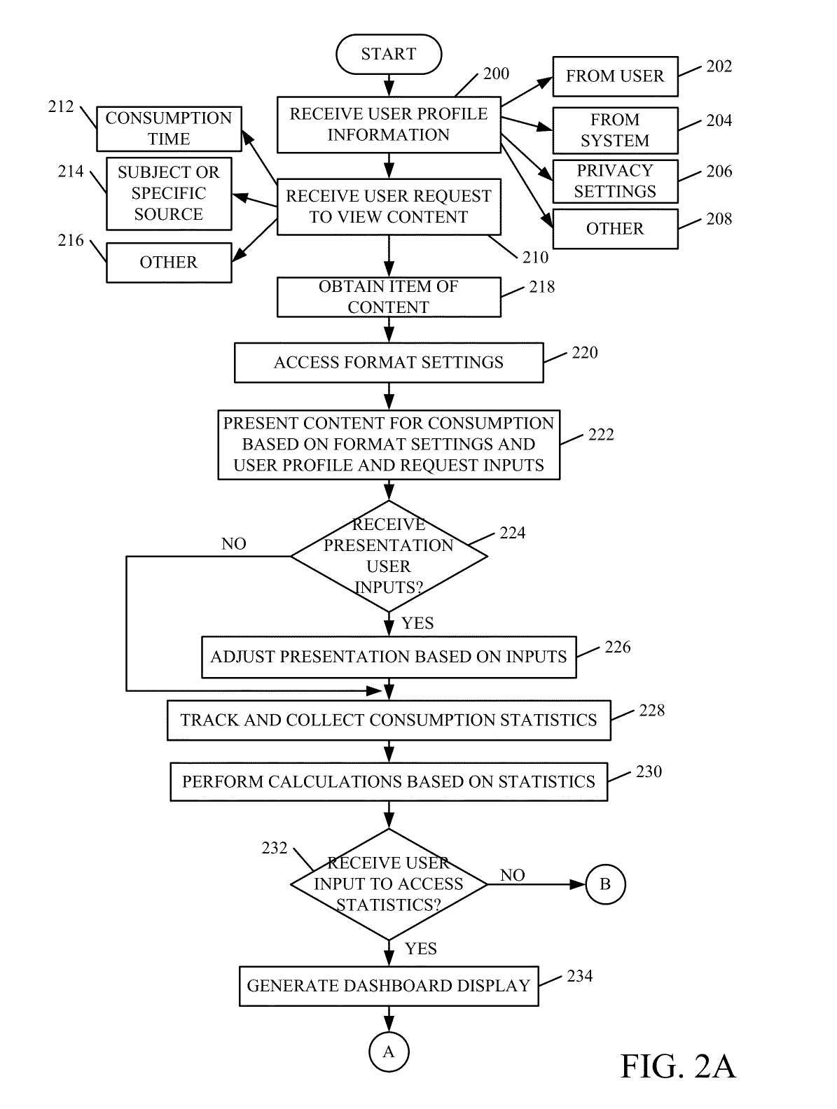

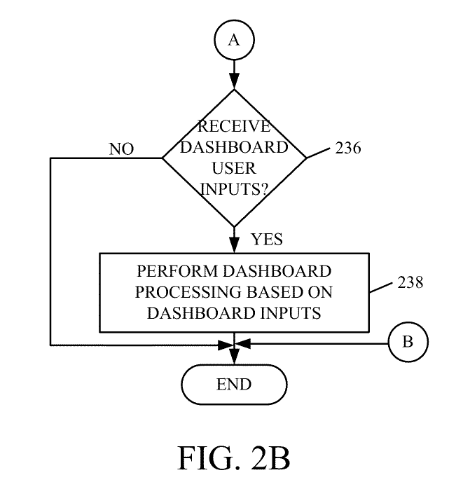

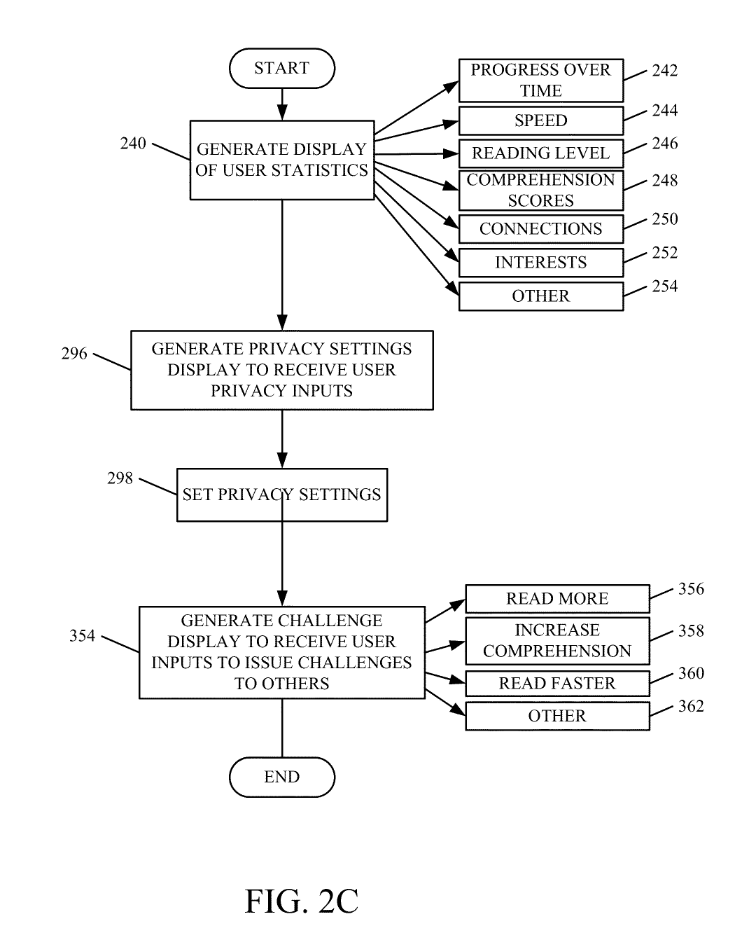

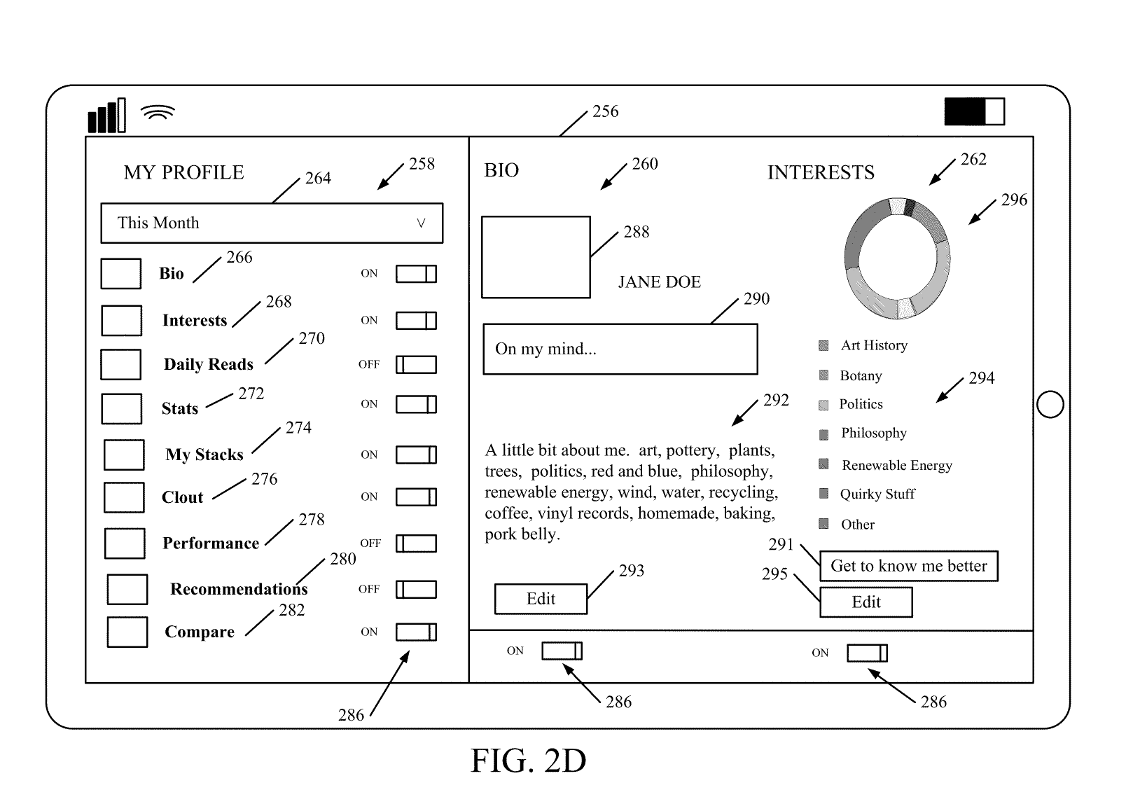

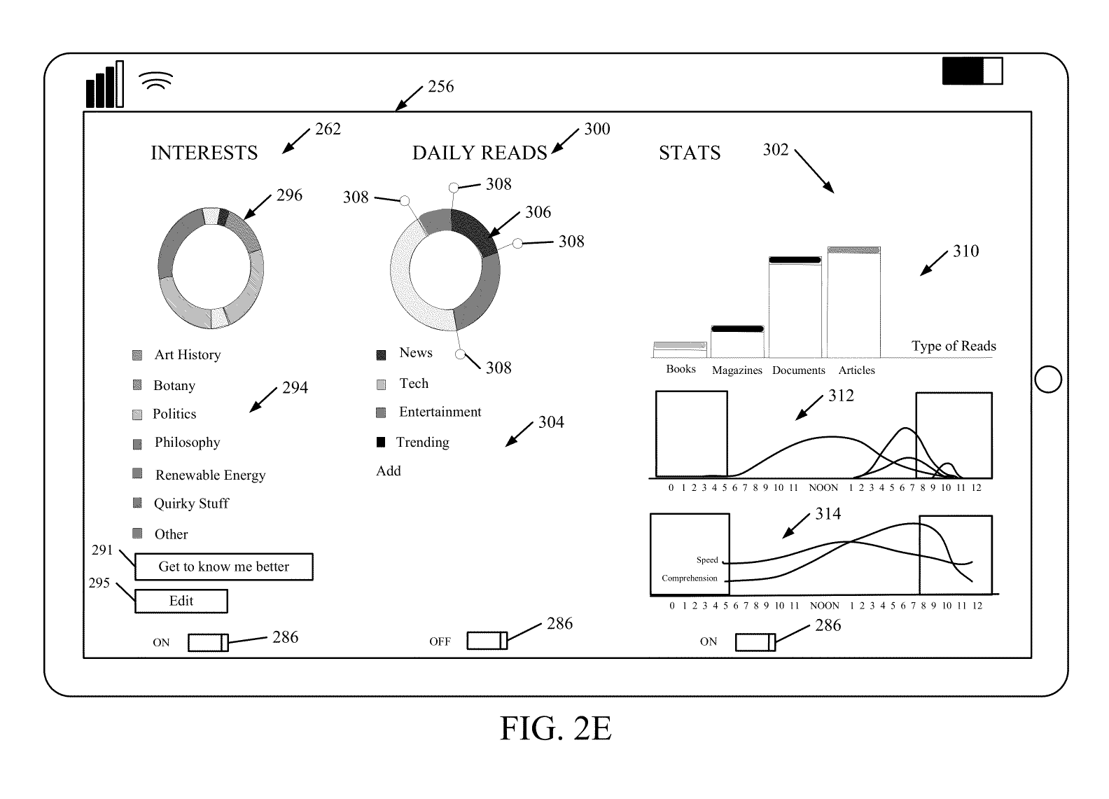

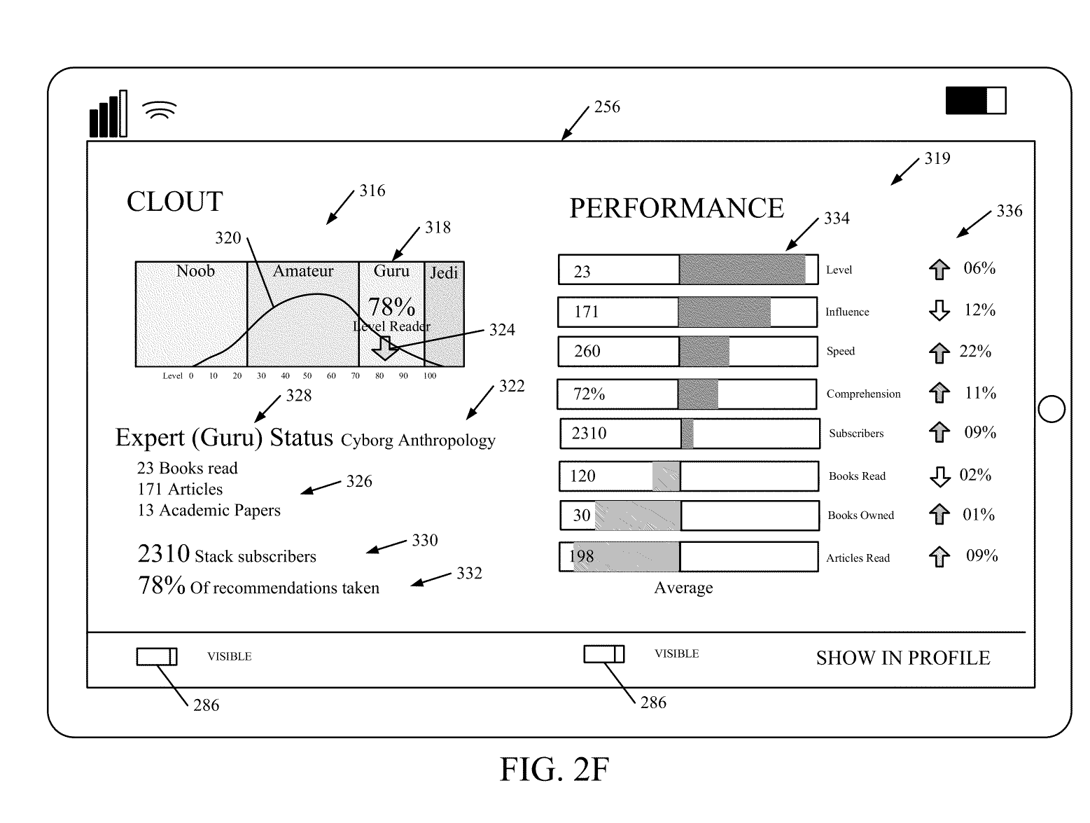

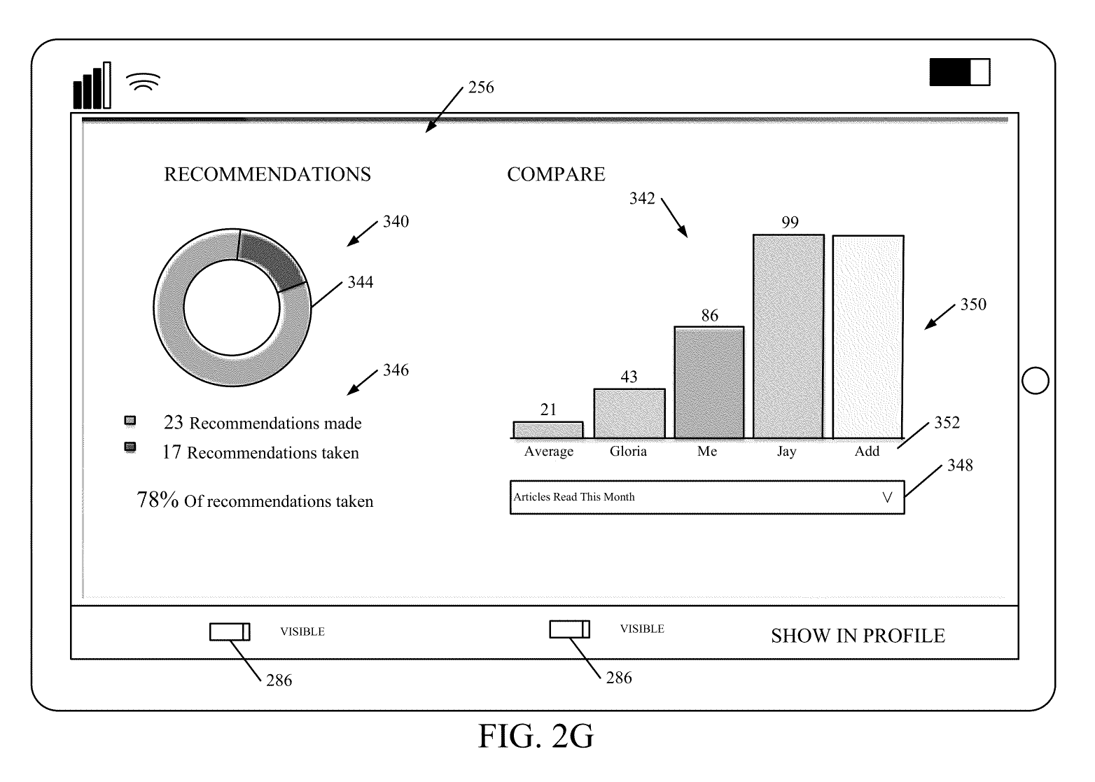

FIGS. 2A and 2B show a flow diagram illustrating one embodiment of the overall operation of content management system 102 shown in FIG. 1. Before describing FIGS. 2A and 2B in more detail, a brief overview is given. User 106 first inputs profile information 162 into system 110, and then accesses and consumes an item of reading material content (such as from a collection 152 of content). In doing so, content presentation system 112 presents the content for consumption by user 106. In addition, reading data collector 126 collects statistics 160 for user 106 that are related to the user's consumption of reading material. Dashboard generator 124 then generates a dashboard that allows the user to view and modify the statistics, if desired.

User 106 first provides user inputs through user input mechanisms 108 on user interface displays 104 to input profile information 162 into content management system 102. Receiving the user profile information is indicated by block 200 in FIG. 2A. Profile information can be obtained from user 106 (as indicated by block 202 in FIG. 2A) or it can be obtained or generated by the system 102, itself, as indicated by block 204. The information can include privacy settings 206 that are input by the user, or a wide variety of other information 208, as is described below.

Once the user has set up a profile, the user illustratively provides inputs to request content for consumption. Receiving a user request to view content is indicated by block 210 in FIG. 2A. The user request can be received in a wide variety of different forms. For instance, the user can provide a consumption time input 212 which indicates the time that the user 106 has to consume the information presented. By way of example, assume that the user is preparing for a meeting and wishes to obtain reading material on renewable energy, and that the meeting occurs in one hour. The user can specify the consumption time (as being an hour or less). In that case, content collection and tracking system 110 retrieves content that can be consumed by user 106 in less than an hour.

User 106 can also provide a subject or a specific source input 214. Where the user provides a subject input, this can be specified using a natural language query. Content collection component 140 in system 110 can then search content sites 118, social networks 116, or other sources 120 (over network 122) for content that matches the subject matter input in the natural language query and return the search results to the user for selection. Of course, the user request to view content can identify a specific source as well. For instance, the user can click on an icon that represents a digital book, a magazine, etc., and have that specific source presented by presentation system 112 for consumption by user 106.

The user can also provide other information as part of the request to view content. This is indicated by block 216 in FIG. 2A.

Once the user has identified the content that user 106 wishes to consume, content collection and tracking system 110 provides the item of content to content presentation system 112 which presents it on user interface displays 104 to user 106, for consumption. Obtaining the item content for presentation to user 106 is indicated by block 218 in FIG. 2A.

In order to present the item of content to user 106, formatting component 168 in content presentation system 112 first accesses format settings 192 and the user's profile information to obtain formatting information which describes how to format the item of content for consumption by user 106. Accessing the formatting settings and profile information is indicated by block 220 in FIG. 2A.

Content presentation system 112 then presents the content for consumption based on the format settings and the user profile and request inputs (e.g., if the user specified a consumption time). This is indicated by block 222 in FIG. 2A. As an example of how profile information can be used, it may be that, in the user profile information 162, the user has indicated that he or she is at a certain grade level (such as 5^{th} grade in grade school). This information can be used in presenting the material for consumption by user 106. That is, the material may be presented in a different way, based upon the reading level of user 106. A number of other examples of this are described below with respect to the remaining figures.

Once the content is presented on user interface displays 104 for user 106, the user can also provide presentation adjustment inputs that adjust the way the content is presented. A given component in content presentation system 112 makes the desired adjustments to the presentation. Determining whether any presentation adjustment inputs are received, and making those adjustments, are indicated by blocks 224 and 226 in FIG. 2A. Examples of these user inputs and adjustments are also described below.

As user 106 is consuming the content, content collection and tracking system 110 is illustratively tracking and collecting consumption statistics corresponding to user 106. This is indicated by block 228 in FIG. 2A. For instance, reading data collector 126 can track statistics that include, reading speed, number of books or articles read, number of words or pages read, reading level, number of different languages read, etc. Further, reading data collector 126 can include an eye tracking component that provides more accurate metrics. In addition, reading comprehension component 136 can be used to generate subject matter quizzes from information that has been consumed or read by user 106. The quizzes can be predefined, or they can be automatically generated. For instance, the quizzes can be already generated and come along with the item of content. Also, reading comprehension component 136 can use a natural language understanding system to identify a subject matter of the item of content being consumed, and generate questions based on that subject matter. Reading comprehension scores can be stored as part of statistics 160 as well. In addition, reading data collector 126 can also track the subjects and keywords associated with consumed material.

System 110 can then perform a wide variety of different calculations, based upon the collected statics. This is indicated by block 230 in FIG. 2A. The calculations can be related to the user's reading performance, reading level, reading speed, etc. When the calculations have been performed, the content management system 102 can receive user inputs from user 106 (through user input mechanisms 108) that indicate that user 106 wishes to review or access statistics 160. Determining whether such inputs are received is indicated by block 232 in FIG. 2A. In response, dashboard generator 124 generates a dashboard display that shows the various views of the collected statistics 160. This is indicated by block 234 in FIG. 2A.

Also, on the dashboard display, dashboard generator 124 can display a variety of user input mechanisms 108 that allow the user to view, modify, or otherwise manipulate the various statistics. Receiving these types of user inputs through the dashboard is indicated by block 236. Based on those user inputs, content collection and tracking system 110 and content presentation system 112 illustratively perform dashboard processing. This is indicated by block 238. Some of the inputs allow user 106 to manage the statistics in various ways. A number of these types of dashboard inputs and dashboard processing steps are described in greater detail below.

FIG. 2C is a flow diagram illustrating one embodiment of the operation of statistics management component 128 in allowing user 106 to view, modify, or otherwise manage the statistics 160. Dashboard generator 124 first generates a display of the user's statistics. This is indicated by block 240 in FIG. 2C. Briefly, as discussed above, the statistics can take a wide variety of different forms. For instance, they can include the user's reading progress over time 242, the reading speed 244, the reading level 246, comprehension scores 248, various connections between user 106 and the content or other items associated with the content that he or she has consumed (such as with the authors, the subject matter, with other people interested in the subject matter of the content, etc.). The connections are indicated by block 250 in FIG. 2C.

The display can also include a display of the user's interests 252. It will be noted that interests 252 can be those expressed directly by user 106, or those implicitly identified by system 102. By way of example, system 102 can use natural language understanding components to understand the subject matter content of the material that has been read by user 106. System 102 can also use social browser 144 to access social networks 116 to identify individuals in a social graph corresponding to user 106. The interests of those individuals, and their reading lists and reading materials can also be considered in calculating the interests of user 106. The interests can be generated on the dashboard display as well. Of course, other statistics 254 can be generated. The statistics can vary, and those mentioned are mentioned for the sake of example only.

FIG. 2D shows one example of a user interface display 256 that shows a dashboard display, or a part of a dashboard display. User interface display 256 illustratively includes a profile section 258 that displays profile information corresponding to user 106, along with a biographical section 260 that displays biographical information corresponding to user 106. In addition, display 256 includes an interest section 262 that displays the various interests of user 106.

Profile section 258 illustratively includes a time selector 264 that allows the user to select a time duration. In the embodiment shown in FIG. 2D, selector 264 comprises a dropdown menu that allows the user to select a period over which the various items in profile section 258 are aggregated.

Profile section 258 also includes a set of user actuatable links in a list below box 264. Each link navigates the user to a display of the corresponding information. The links include biography link 266, interest link 268, daily reads link 270, statistics link 272, my stacks link 274, public stacks link 276, performance link 278, recommendations link 280 and compare link 282. When user 106 actuates biography link 266, for instance, the biography portion 260 is displayed. When the user actuates interests link 268, the interest section 262 is displayed, etc.

It can also be seen that each link is associated with a security actuator 286. The security actuators can be moved to an on position or an off position. This indicates whether the information is publically available to others, or only privately available to the user, respectively. For instance, the security actuator corresponding to link 266 is in the on position, while the security actuator corresponding to the daily reads link 270 is in the off position. Thus the biography section 260 of the dashboard for user 106 will be publically available while the daily reads section will not. The user can set each security actuator using a point and click or drag and drop user input, such as using a touch gesture, etc.

In the embodiment shown, the bio section 260 and interests section 262 are both displayed and they also each have a corresponding privacy actuator 286. Bio section 260 illustratively includes an image portion 288 that allows the user to input or select an image that the user wishes associated with his or her biographical information. A status box 290 allows the user to post a status, and textual bio portion 292 allows the user to write biographical textual information.

Interests section 262 not only includes a list of interests at 294, but also a percentage illustration 296 that is visually associated with the lists of interests in section 294 to indicate how much of the user's attention is dedicated to each of the items in list 294. The interests section 262 also includes a “Get to know me better” button 291 which can be actuated to show more detailed information about the user's interests. As is described in detail below, the information displayed on dashboard display 256 may not represent user 106 in a way that he or she wishes to be represented to the public. Therefore, the user can turn off various statistics (by setting the privacy settings using privacy actuators 286) to indicate that they are not available to the public. In addition, in one embodiment described below, the user can also illustratively modify the displayed statistics as desired. FIG. 2D shows, for instance, that the user can edit bio section 260 by actuating edit button 293 and the interests section 262 by actuating edit button 295. Actuating an edit button navigates the user to an edit page where the user can modify the corresponding section. These modifications may change system behavior as well. For instance, modifying the interests section 262 not only affects what is displayed in the user's public profile, but also recommendations made by the system.

Referring again to FIG. 2C, once the dashboard display 256 is generated, it illustratively includes privacy setting actuators 286 that allow the user to make privacy settings on an individual category basis. Generating the display of the privacy settings is indicated by block 297 in FIG. 2C. Receiving the privacy settings from the user and setting those privacy settings so that the profile information is public or private, as desired by the user, is indicated by block 298 in FIG. 2C.

It will also be noted that, in one embodiment, dashboard display 256 is scrollable. Thus, the user can scroll to different portions of the dashboard. For instance, if the user interface display on which display 256 is presented is a touch sensitive display screen, the user can use a touch gesture to scroll to other sections of the dashboard display 256. By way of example, if the user uses a swipe left touch gesture, then display 256 will illustratively scroll to other sections on the dashboard display.

User interface 256 shown in FIG. 2E, for example, shows that the user has scrolled the dashboard display to the left so that interests section 262, daily reads section 300, and statistics section 302 are shown. Daily reads section 300 shows (by subject matter shown in list 304) the types of material that user 106 reads on a daily basis, and the types of feeds and content that are provided to the user on a daily basis. It can be seen that they are visually associated with chart 306 which shows, in a graphical way, the percent of content consumed by user 106 in each of the categories in list 304. Chart 306 shows that each category illustratively has a handles 308 associated with it. The user can change the percent (or volume) of content provided as a daily read to the user, by content collection component 140 by moving the handle 308 to either increase or decrease the area on chart 306 associated with that particular daily read category. For instance, if the user wishes to increase the amount of news content provided as a daily read, the user can grap handle 308 adjacent the news section of chart 306 and move it downward around chart 306 to increase the amount of chart 306 allocated to that category.

Statistics (or stats) section 302 shows a number of exemplary statistics. In one embodiment, a reading material type section 310 shows the volume of reading material types (such as books, magazines, documents, articles, etc.) that the user reads. Volume graph 312 shows the different types of reading material that are consumed at the different times of the day. The time period can be changed as well to show this metric displayed over a week, a month, a year, a decade, etc. Each line in graph 312 is illustratively visually related to one of the types of reading materials shown in graph 310. Therefore, the user can see, during a given day, what types of material the user is reading, how much of each type, and at what times of the day they are being read.

Performance chart 314 illustratively graphs reading speed and reading comprehension against the hours of the day as well. Again, this can be shown over a different time period (a week, month, etc.) as well. Therefore, the user can see when he or she is most efficiently reading material (in terms of speed and comprehension), etc.

FIG. 2F shows yet another embodiment of display 256 in which the user has scrolled even further. FIG. 2F shows that display 256 now displays clout section 316 and performance section 318. Clout section 316 indicates whether user 106 is becoming well read on any given subject. In one embodiment, system 110 uses expertise calculator 132 (shown in FIG. 1) to calculate this. The calculation of how much clout (or influence and expertise) user 106 has in a given subject matter area can be calculated in a wide variety of different ways. For instance, it can be based on the number of items of material that the user has consumed (or read). It can be based on the different types of material (for example, a scholarly paper may be weighted more heavily than a blog article or recreational article). It can also be based on other users. For instance, recommendation component 134 (shown in FIG. 1) illustratively generates a user interface display that allows user 106 to recommend articles on various subject matter areas to other users. It also illustratively tracks how many of those users take the recommendations made by user 106. This is indicated generally at 332 in FIG. 2F. Therefore, the determination of how much influence user 106 has in a given subject matter area can be based on that as well. It can be based on other things as well, such as how many people have read this user's content, if this user has written and published content themselves. In one embodiment, it can also pull in expertise from other systems that vet experience and expertise (for example, endorsements on professional or social network sites, etc.).

In the embodiment shown in FIG. 2F, clout section 316 shows a graph 318 that illustrates (using a bell curve 320) the distribution of the clout of other users of similar systems with respect to the subject matter shown in subject matter area 322. In the specific example shown in FIG. 2F, the subject matter area is “Cyborg Anthropology”. Therefore, graph 318 shows the bell curve 320 indicating the distribution of users in the subject matter area Cyborg Anthropology. The graph 318 also shows a visual indicator 324 that indicates where the present user falls in graph 318. Subject matter section 322 indicates generally at 326, the number of different types of reading material that have been consumed by user 106 in the subject matter area of Cyborg Anthropology. It also, shows, in status section 328, that the user has obtained “expert” or “guru” status in that subject matter area.

Expertise calculator 132 can also calculate the level of expertise that the user has based on how many other users subscribe to follow the present user in this subject matter area. Subscription component 142, shown in FIG. 1, illustratively allows user 106 to subscribe to other peoples stacks of reading material and also enables others to subscribe to the stacks of user 106. For instance, user 106 may have a plurality of different stacks (or collections) of reading material. Other users can illustratively subscribe to that section to view the reading material that has been collected by user 106 in that subject matter area. Expertise calculator 132 can base the level of expertise of user 106 on the number of subscribers to the stack corresponding to that subject matter. This is indicated generally at 330 in FIG. 2F.

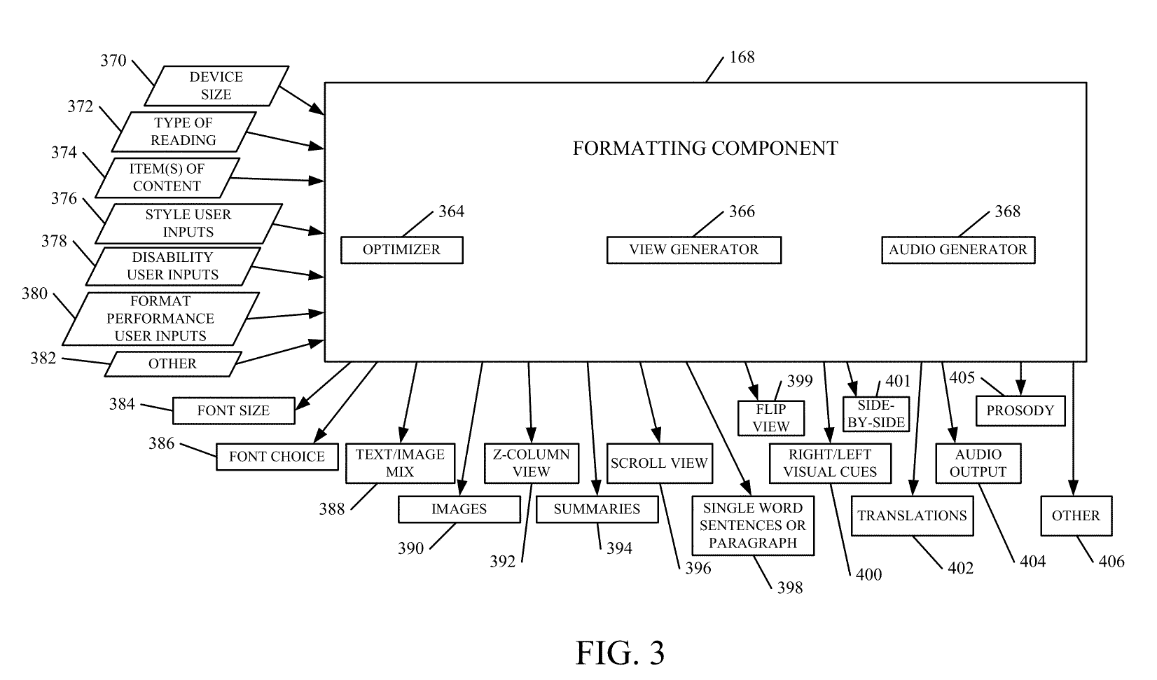

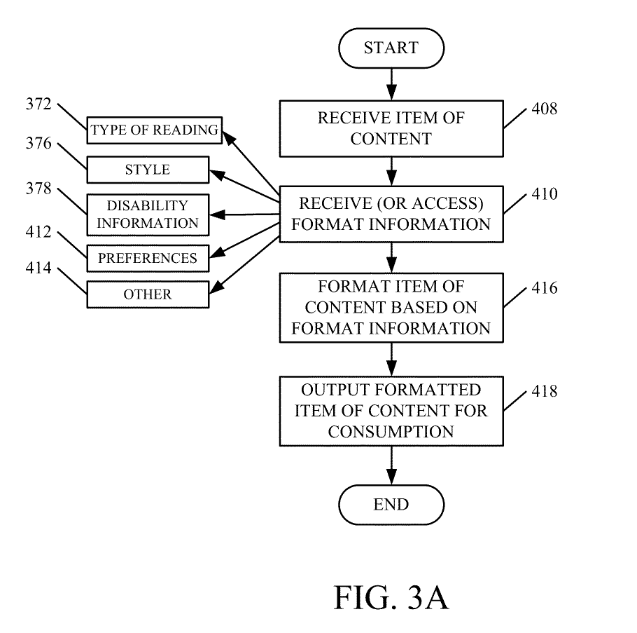

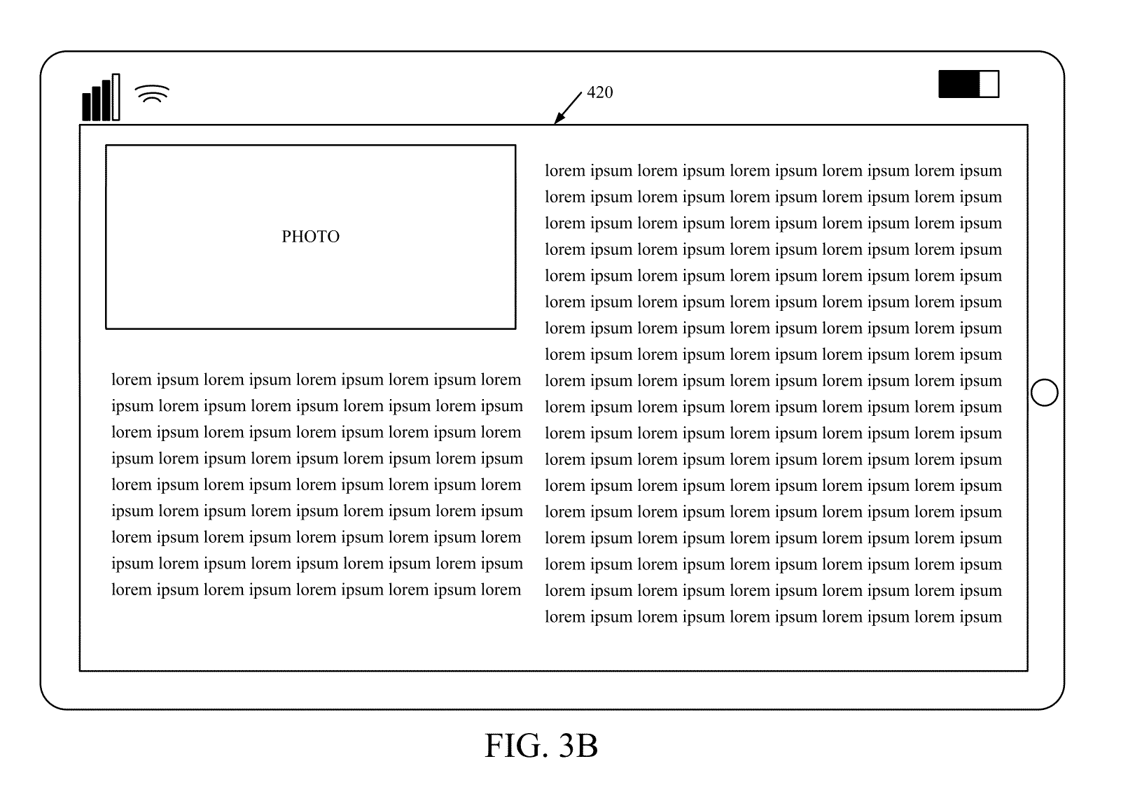

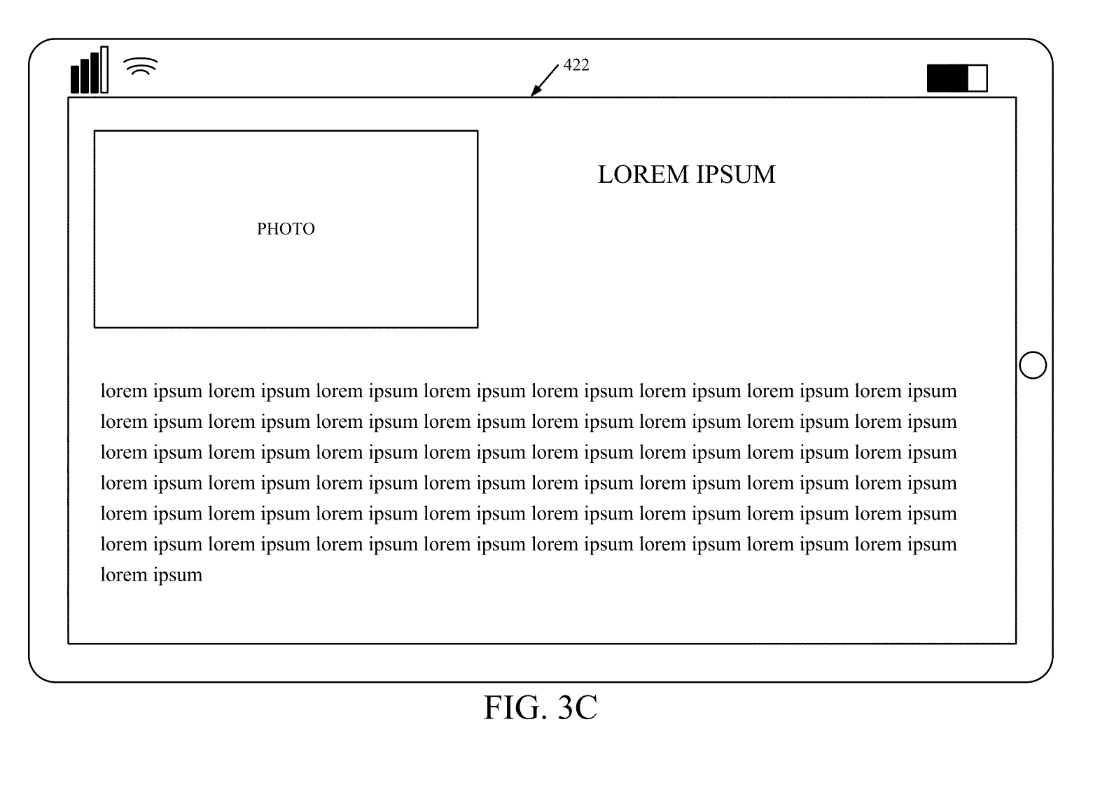

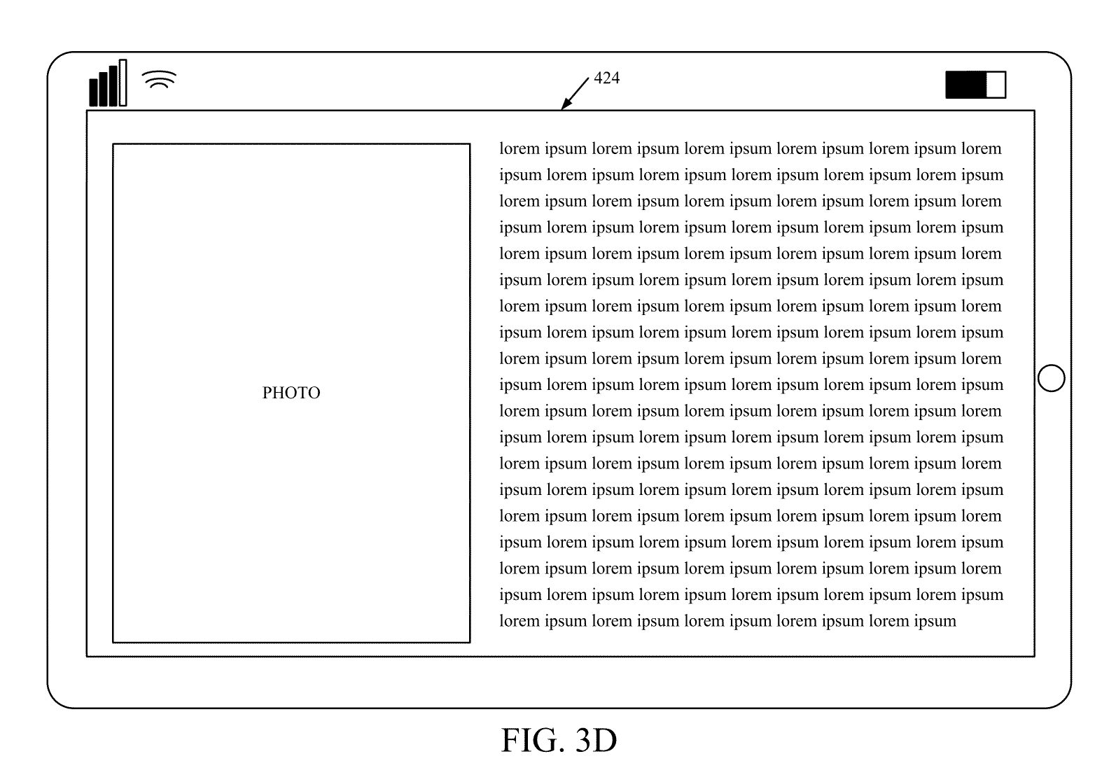

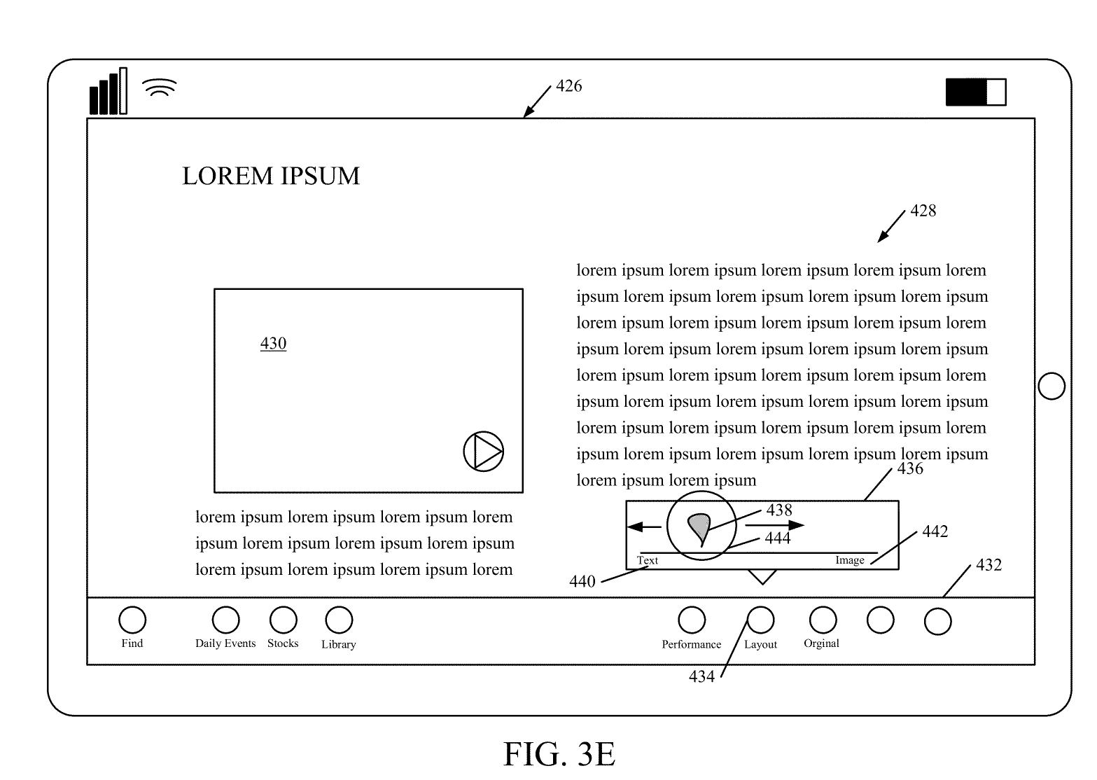

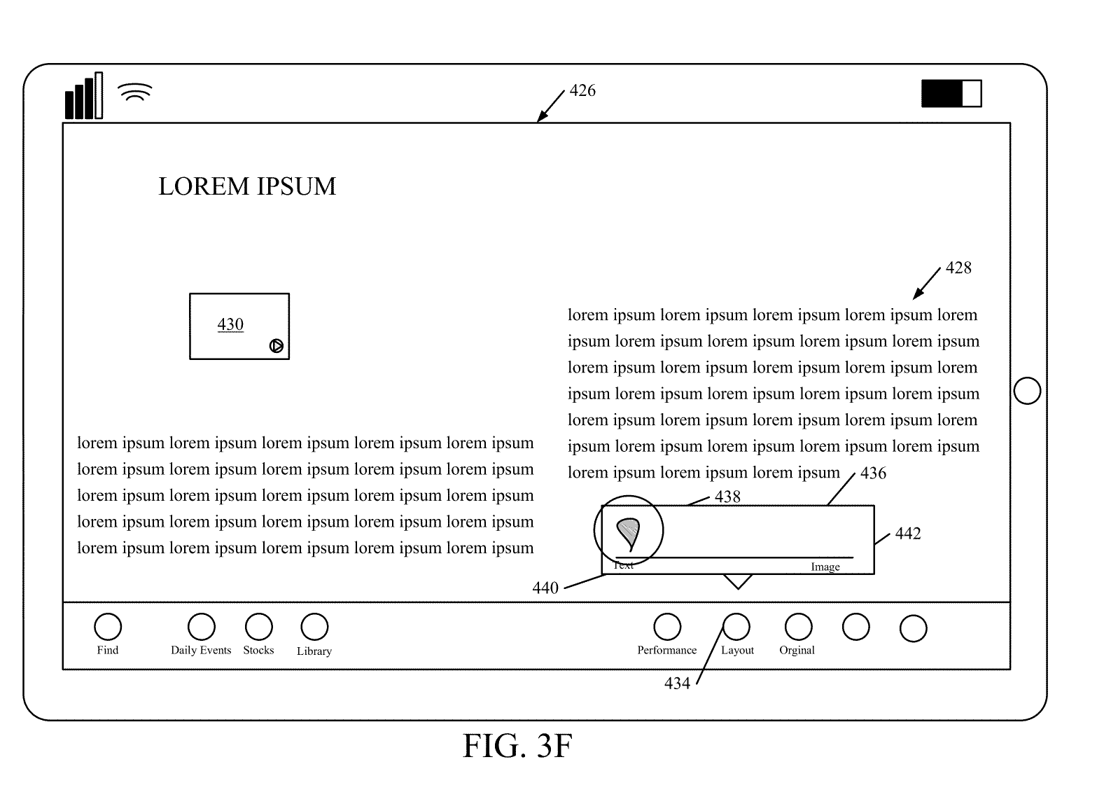

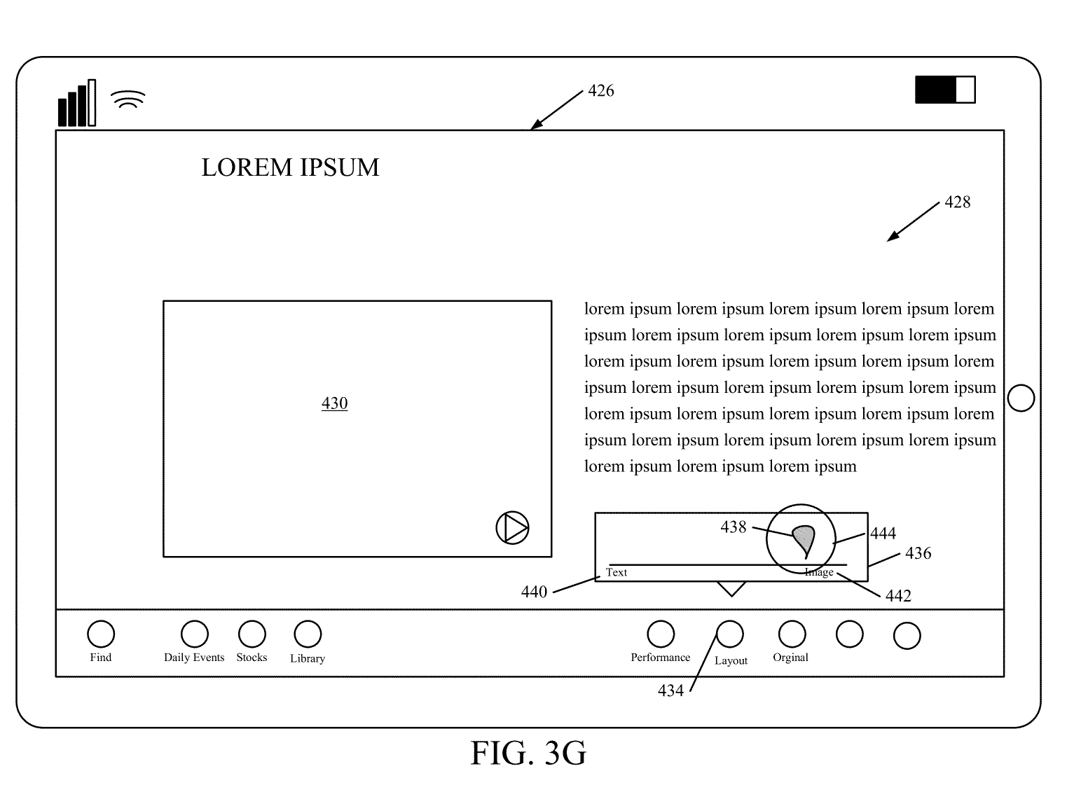

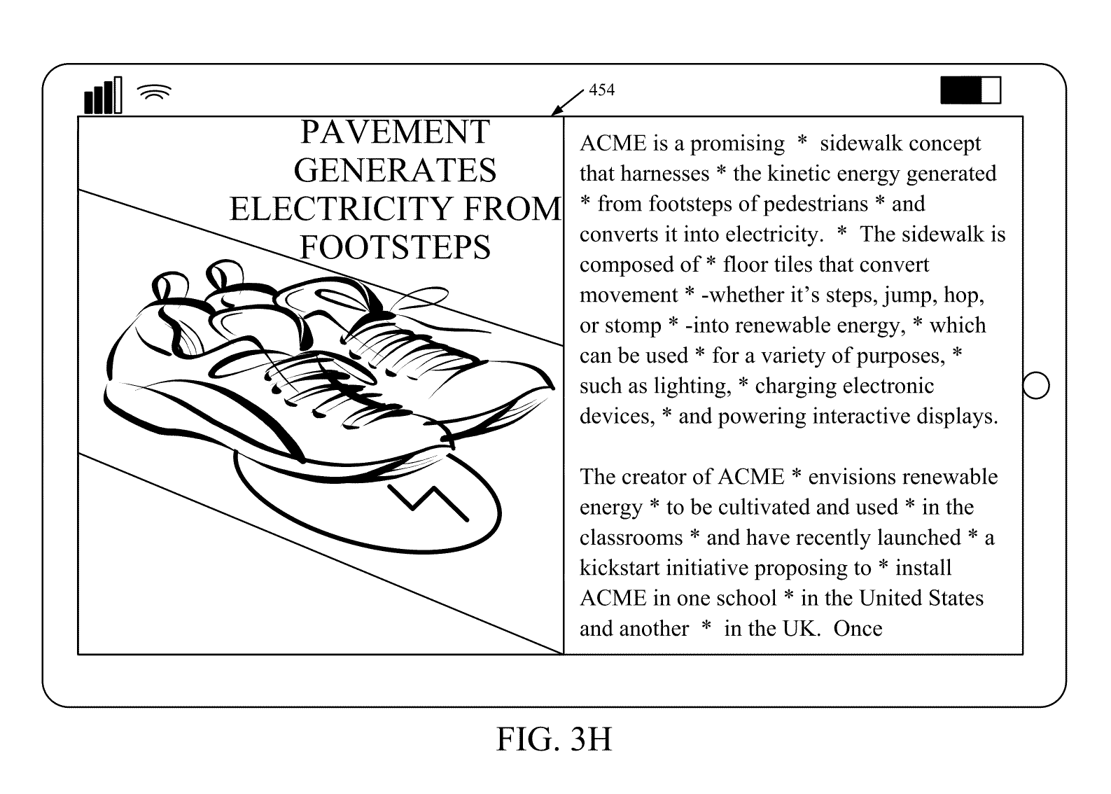

Performance section 319 illustratively includes a performance metrics section 334 and a trending section 336. Metric section 334 illustratively shows a user level across a variety of metrics but relative to average. Metrics shown in metric section 334 include the user's reading level, the amount of influence a user has across a variety of subject matter areas, the user's reading speed and comprehension, the number of subscribers the user has, the number of books read, and books owned in the user's collection, and the number of articles read. Trending section 336 indicates whether the value for each corresponding metric is up or down during this time period, and the percent of increase or decrease, related to a previous time period. It will be noted, of course, that the metrics shown in FIG. 3F are exemplary only, and other metrics, additional metrics or fewer metrics, can be used as well.

FIG. 2G shows another embodiment in which the user has scrolled dashboard display 256 even further. FIG. 2G shows recommendations section 340 and compare section 342. Recommendations section 340 includes graph 344 and data section 346. Graph 344 shows the amount of recommendations made by user 106 and the amount of those recommendations that have been taken, in graphical form. Section 346 shows this in textual and numeric form. It can be seen that user 106 has made 23 recommendations and 17 of them have been taken, meaning that 78 percent of the user's recommendations have been taken. Graph 344 illustrates this in graphical form.

Compare section 342 allows user 106 to choose a basis for comparison to other users using dropdown menu 348. For instance, the user has chosen the number of articles read this month as the basis for comparison. The other users to which user 106 is compared are shown in graph 350. The user can illustratively select additional users for comparison by clicking add button 352. This brings up a display that includes input mechanisms for selecting or searching for additional people to add to the comparison. People can be from the user's contact list, from the user's social network or social graph, others in the user's age group or grade level, individuals at the user's work, or other people as well.

It will also be noted that, in one embodiment, dashboard generator 124 can illustratively generate a user interface display that allows user 106 to challenge other users to various competitions. Generating the display and receiving user inputs to issue challenges to others is indicated by block 354 in FIG. 2C. The challenges can include a wide variety of different types of challenges. For instance, user 106 can provide inputs to challenge other users to read more as indicated by block 356, to increase reading comprehension as indicated by block 358, to read faster as indicated by block 360, or to perform some other actions as well, as indicated by block 362.

FIG. 3 is a block diagram showing one embodiment of formatting component 168 in more detail. In the embodiment shown in FIG. 3, formatting component 168 includes optimizer 364, view generator 366 and audio generator 368. FIG. 3 shows that formatting component 168 can include a wide variety of inputs, such as the size of the device displaying the content, indicated by device size 370, the type of reading 372 that the user is engaging in, the various items of content 374 that are displayed to the user, style user inputs 276 that indicate a display style desired by the user, any disability user inputs 378 that include reading disabilities (such as eyesight impairment, dyslexia, etc.), format performance user inputs 380 or other inputs 382. Formatting component 168 then generates a wide variety of different types of outputs, formatting the items of content 374 that are presented to the user according to the format settings. Formatting component 169 can regulate font size 384, font choice 386, text/image mix 388, it can provide the presentation of images 390, a z-column view 392, summaries 394, a scroll view 396, a single word or paragraph view 398, flip view 399, right/left visual cues 400, side-by-side view 401, translations 402, audio outputs 404, prosody 405 or a wide variety of different or additional outputs 406. Some of these inputs and outputs and format processing will now be described in more detail.

FIG. 3A is a flow diagram illustrating one embodiment of the overall operation of formatting component 168 shown in FIG. 3. FIG. 3A shows that formatting component 168 first receives an item of content that is to be displayed for consumption by user 106. Receiving the item of content is indicated by block 408 in FIG. 3A. Formatting component 168 then accesses format settings 192 in data store 190 (previously shown in FIG. 1) for user 106 and can also receive additional format settings or format information from the user as well. This is indicated by block 410. As described above, the format information can include the type of reading that the user is engaged in 372, the style 376 that the user wishes the content to be displayed in, any disability information 378, other preferences 412, or other information 414.

Formatting component 168 then formats the item of content based upon the format information and outputs the formatted item of content for consumption by the user. This is indicated by blocks 416 and 418 in FIG. 3A. In the embodiment discussed herein, formatting component 168 can format the information by simply rendering the information according to the format preferences illustrated by user 106, or it can even modify the information (such as optimize it) based on a variety of other criteria.

In one embodiment, for instance, formatting component 168 modifies the content to enhance speed reading. The length of time needed to consume a piece of content or collection of content can be estimated by component 168 either based on average reading speed or based on the specific users reading speed. If the content includes multimedia content (such as videos) then the viewing time can be factored in as well. This can be used to summarize, expand, or curate a collection of content to fill a specific amount of time.

The information can also be modified by formatting component 168 based on the user's reading level. The reading level can be obtained from profile information 162, or otherwise. For instance, analyzer 176 can analyze the content read by the user to identify words in the content and compare it against a data store of words ranked according to reading level. Format component 168 can then be used to insert synonyms to replace words in the content to match a reading level for user 106. It can be used to enhance the reading experience for students, young readers, or people learning a new language. It can also be used to increase the reading level or to challenge students to encourage learning.

The same type of formatting modification can be applied to text with industry or discipline-specific terms. For instance, a user 106 reading a legal document may have legal terms in the document replaced with language that is more readily understandable. In addition, an item of content with a large number of acronyms that are specific to a certain field can have the acronyms filled in for someone that is not well versed in that field.

Formatting component 168 can also modify the item of content based on any reading disabilities of user 106. Font options can include a font specifically designed to enhance reading capabilities for people with dyslexia. The right/left visual cues 400 (shown in FIG. 3) can also be displayed on a screen above or below text to assist dyslexic readers with right/left differentiation. Word or sentences, or even paragraphs can be isolated (as single word, sentence or paragraph displays 398 shown in FIG. 3) and shown one at a time as opposed to in a paragraph or longer form in order to help those who struggle with reading larger chunks of text.

In addition, for those just learning to read, component 168 can modify the text of an item of content by providing extra large text size to assist in character differentiation. Fewer words can be shown at a time, and the user can illustratively provide a user input selecting a word that they do not know how to say, and that can trigger an audio clip of that word, generated by generator 368, that pronounces the word for the user. Audio clips can be associated with individual words, sentences, or more, and they can easily be actuated to repeatedly render the audio version of the text. In addition, images or definitions can be displayed in line with the text, in order to assist users in understanding unknown words.

Formatting component 168 can also modify the content for readers who are reading in a second language. For instance, formatting component 168 can use machine translator 182 to translate an entire document, or a collection of documents, although translations can be crowd-sourced translations as well, in a community-based system. It can provide user input mechanisms on the user interface displays in order to allow a user to translate even a single word. In addition, formatting component 168 can format the text in a split-screen view to show text in the original language on one side and the parallel text in the user's mother tongue on the other side, as translations 402. Formatting component 168 can also allow the user to select a word or phrase (such as by tapping it on a touch sensitive screen) and simply display that word or phrase (or hear the audio version of that word or phrase) in an alternate language (that was perhaps preselected in the user's profile or format settings).

As briefly mentioned above, formatting component 168 can format the content based on the device size 370 that the user is using to consume the content. Simply because a screen is larger, that does not automatically mean that it should be filled with text to read. Conversely, simply because a screen is smaller, it should not be filled with tiny text. Default font size can illustratively be calculated based on screen size and device type with modifications available to suit personal preference. Therefore, optimizer 364 can obtain the device size 370 and automatically default to a given font size and layout, etc. However, the user can also choose to modify the font size and layout, to make it different from the default.

Optimizer 364 can also use view generator 366 to generate a view that is modified based on the type of reading 372 that user 106 is engaging in. For instance, if the user is skimming, engaging in nonlinear navigation, the view of the content can be generated with a navigation bar along the side of the text that represents the chapters or sections of the book, and are to scale. Therefore, a longer chapter is represented as a bigger tab on the bar, than a shorter chapter. Moving a cursor along the bar allows user 106 to jump to a specific place in the content (e.g., in a book). As a current location indicator on the display moves, view generator 366 can cause pages to flip in real time which assists the user to quickly skim sections of text and images.

Optimizer 364 can also modify the item of content to enhance understanding. For instance (prosody which comprises queues on the rhythm, stress and intonation of speech) can be added not only to enhance understanding of the text, but also to enhance reading the text out loud. Prosody can be added to the content by changing the display so that the size of different words is modified to indicate which words are emphasized, to add line breaks in between phrases to indicate meaning, etc. In addition, symbols, such as those found in music, can be displayed to help indicate the intended tone of a sentence. For example, a sarcastic sentence may be intonated differently than a question.

Syntactic queues can also illustratively be manipulated by user 106. For instance, formatting component 168 can divide the content into three levels of syntactic queues. The first include the commas, periods, etc., as seen in a conventional book. The second level is to parse sentences by phrases, as used to aid in prosody generation. The third is a single word at a time. In one embodiment, the user can illustratively switch between these modes depending on desired reading style.

In another embodiment, the user can indicate a cross-referencing reading style. In that embodiment, view generator 366 illustratively provides two different content items open side-by-side, for cross referencing. Of course, this can be two pages of the same item of content as well. In this way, user 106 can flip through and search each item independently. The user can also illustratively create links between the two items of content so that they can be associated with one another.

FIGS. 3B-3H illustrate various examples of different types of formats that can be generated by formatting component 168. FIG. 3B shows one exemplary user interface display 420 showing text in a flip view using a two-column page model. If the user interface display screen is a touch sensitive screen, the user can simply use right-left touch gestures to “flip” through pages of the electronic item of content (e.g., an electronic book). This view is provided for an active reading style that often includes, for example, note-taking or acting on content like looking up more information or having a discussion about the content. It is formatted to facilitate side-by-side note-taking so a digital notebook can be pulled over half the screen without blocking any content. It also has side margins that are just wide enough to allow for a side-panel to be surfaced without obscuring any text. This side-panel can contain a discussion surface, more information, etc.

FIG. 3C shows one embodiment of a user interface display 422 that is an example of a scroll view (shown by block 396 in FIG. 3). The entire article or a single chapter is illustratively displayed in a single continuous column that the user can scroll up and down on display 422, and swipe side-to-side to access the next or previous article in a stack of articles.

FIG. 3D shows yet another user interface display 424 which illustrates an example of a rich view that emphasizes visual content. It provides an image which is similar to flipping through a magazine, with large, visually enhanced images.

FIGS. 3E-3G are user interface displays showing one illustrative user input mechanism for switching between displays which change the ratio of images to text. In the embodiment shown in FIG. 3E, user interface display 426 includes textual material 428 and an image 430. A task or tool bar 432 has been invoked by the user using a suitable user input mechanism (such as a swipe gesture, a click, etc.). The user has illustratively actuated layout button 434. This causes formatting component 168 to generate a pop-up mechanism 436. In the embodiment shown in FIG. 3E, mechanism 436 is a visual slider that includes a wiper 438 that can be moved between one extreme 440 where text is emphasized, and the other extreme 442 where images are emphasized. The user can do this, for example, by placing a cursor 444 over wiper 438 and moving it in either direction. Also, where the display is a touch sensitive display, the user can simply tap or touch wiper 438 and drag it one direction or the other. FIG. 3F shows one embodiment of user interface display 426 where the user has dragged wiper 438 toward the text side 440 of slider 436. This causes formatting component 168 to automatically reflow the content to reduce the size of image 430 thus filling the display with more text 428.

FIG. 3G shows one embodiment of user interface 426 where the user has moved wiper 438 toward the image side 442 of slider 436. Formatting component 168 thus reflows the content to enlarge image 430 and reduce the amount of text 428 shown on the display.

In another embodiment a user interface display can display text in a visual-syntactic text format. This type of format transforms text that is otherwise displayed in block format into cascading patterns that enable a reader to more quickly identify grammatical structure. Therefore, for example, if user 106 is a beginning reader, or is learning a new language, component 168 may display text using this format (or it may be expressly selected by user 106) to enable the user to have a better reading experience and more quickly comprehend the content being read.

It should also be noted that the content can be made entirely of text with images pulled out, or the images can be enlarged to full screen size, removing the text. On the latter end of the spectrum (where text is hidden and only images are shown) text can be formed as captions on the backside of images and can be shown when a suitable user input is received (such as a tap on an image on a touch sensitive screen). On the end of the spectrum where the reading material is entirely text, the images can be hidden or marked only with a small icon and surfaced when those icons are actuated. In addition, for content that has no images, images can be automatically identified using content collection component 140 to search various sites or sources over network 122 to identify suitable images. Images can be sourced by third parties as well. This allows the system to accommodate different learning styles or preferences. For example, a visual learner may prefer more images while a verbal learner may prefer more text, etc.

In yet another embodiment a user interface display displays prosody information 405 (shown in FIG. 3) along with the text. Formatting component 168 basically displays the text in a visual way that enables the user to better understand the proper pitch, duration, and intensity for the text. Of course, the pitch, duration and intensity can be displayed in a combination as well.

FIG. 3H shows a user interface display 454 that illustrates separation of phrases or other linguistic structures in the text by markers to enhance understanding. This can be helpful in a wide variety of different circumstances, such as with a new reader, a reader learning a new language, a reader with a reading disability, etc.

It will be noted that the user interface displays described above with respect to FIGS. 3-3H are shown for the sake of example only. While a wide variety of different formats are shown, they are given only for the sake of example and other formats could be generated as well.

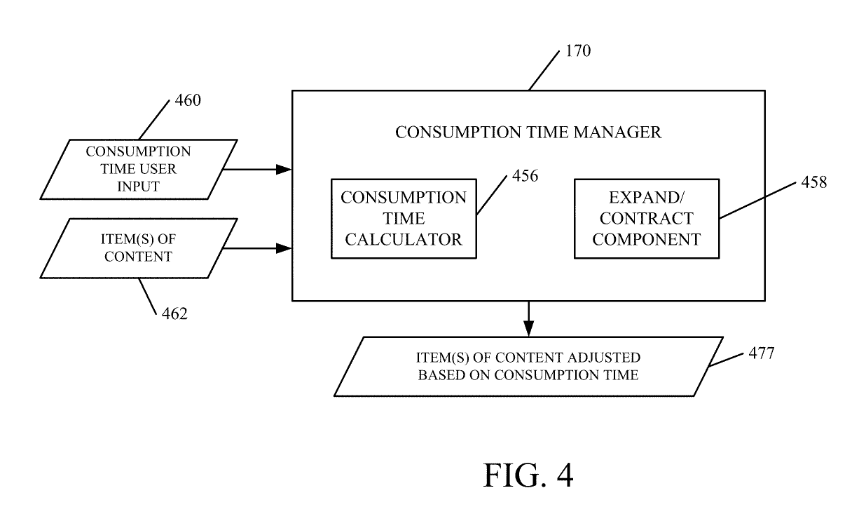

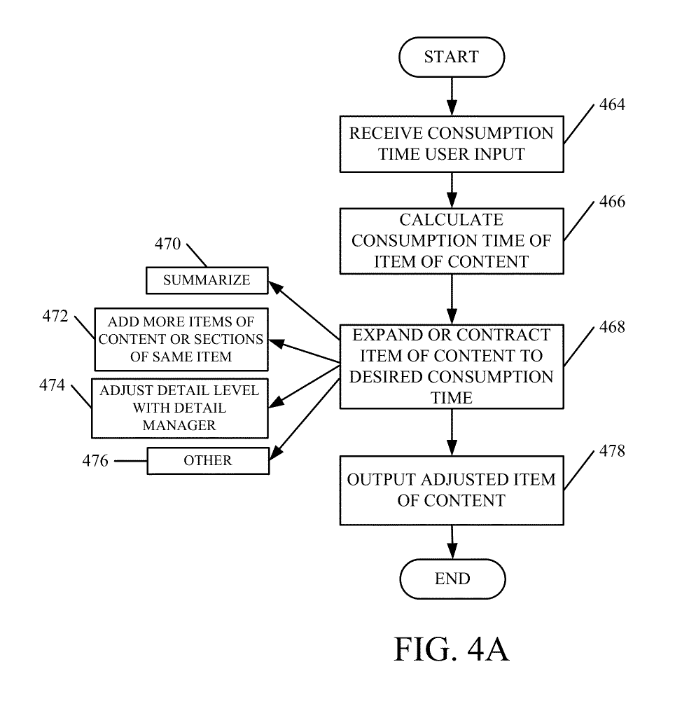

FIG. 4 is a block diagram showing one embodiment of consumption time manger 170 in more detail. FIG. 4 shows that consumption time manager 170 illustratively includes consumption time calculator 456 and expand/contract component 458. Consumption time manager 170 is used when the user provides a consumption time user input 460 which indicates a consumption time that the user has within which to consume a collection of content. Content collection and tracking system 110 then identifies content to be added to the users collection and provides the items of content to be added to the users collection and provides the items of content 462 to consumption time manger 170.

FIG. 4A is a flow diagram illustrating one embodiment of the overall operation of consumption time manager 170. Receiving the consumption time user input 460 is indicated by block 464 in FIG. 4A. Consumption time calculator 456 calculates the consumption time of the items of content 462 provided by content collection and tracking system 110. Calculating the consumption time for the items of content is indicated by block 466 in FIG. 4A.

Expand/contract component 458 then expands or contracts the content in the items of content being analyzed, in order to meet the desired consumption time. This is indicated by block 468 in FIG. 4A. For instance, where the identified items of content are too long, expand/contract component 458 can use summarization component 178 (shown in FIG. 1) to summarize the content as indicated by block 470 in FIG. 4A. Where the item of content can be consumed in a shorter amount of time, then expand/contract component 458 can request content collection and tracking system 110 to add more items of content, or additional sections of the same content (e.g., more chapters of a book). This is indicated by block 472 in FIG. 4A.

Expand/contract component 458 can also use detail manger 172 to adjust the level of detail displayed for each item of content. This is indicated by block 474 in FIG. 4A. Of course, expand/contract component 458 can use other components to expand or contract the content as well, and this is indicated by block 476.

System 112 then outputs the adjusted items of content 487 (in FIG. 4) for consumption (e.g., for reading) by the user. This is indicated by block 478 in FIG. 4A.

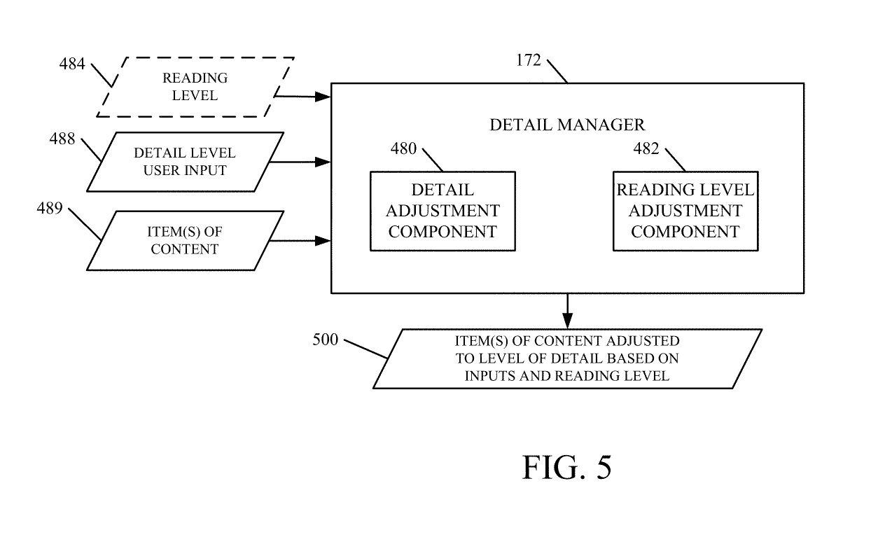

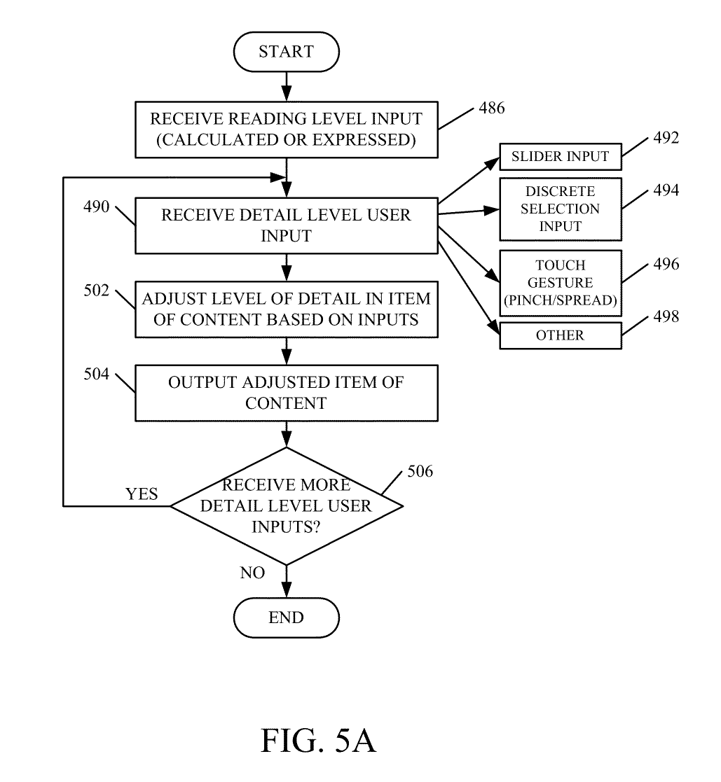

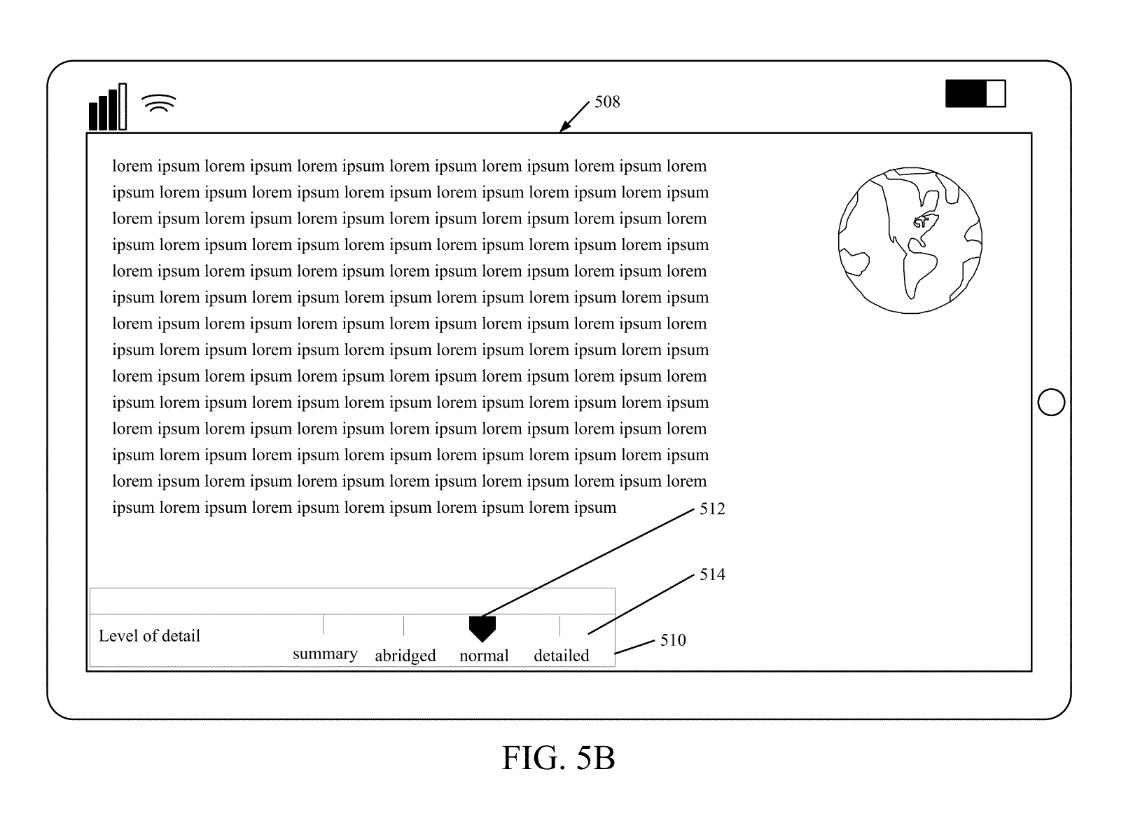

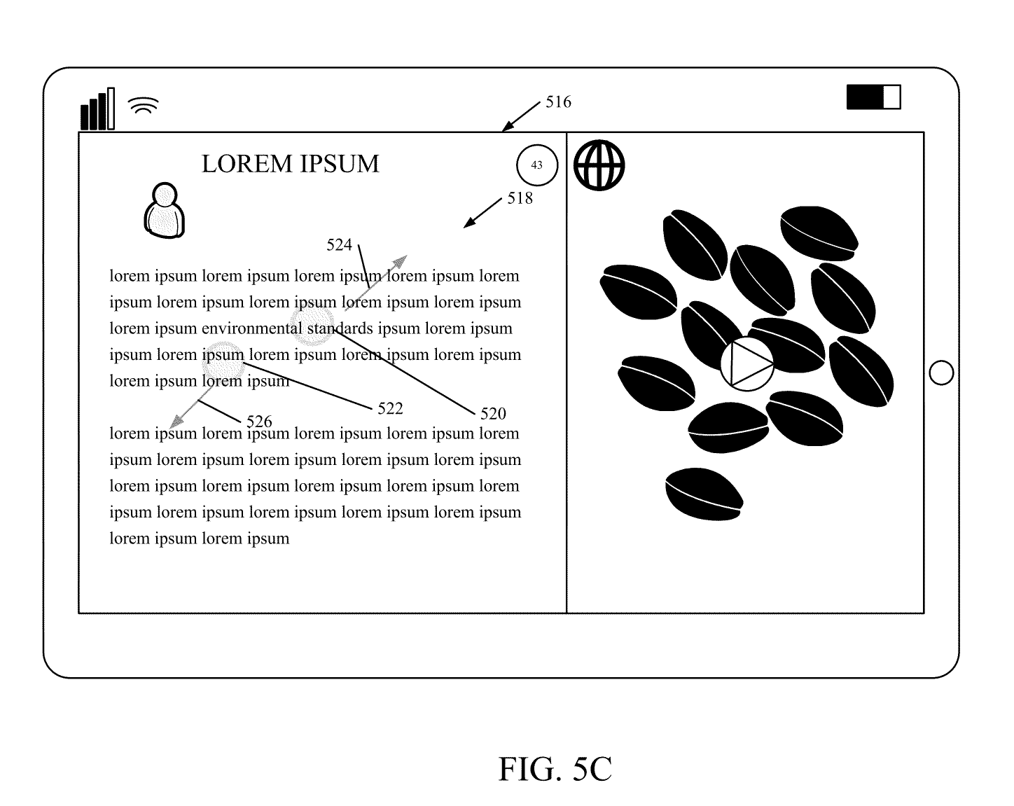

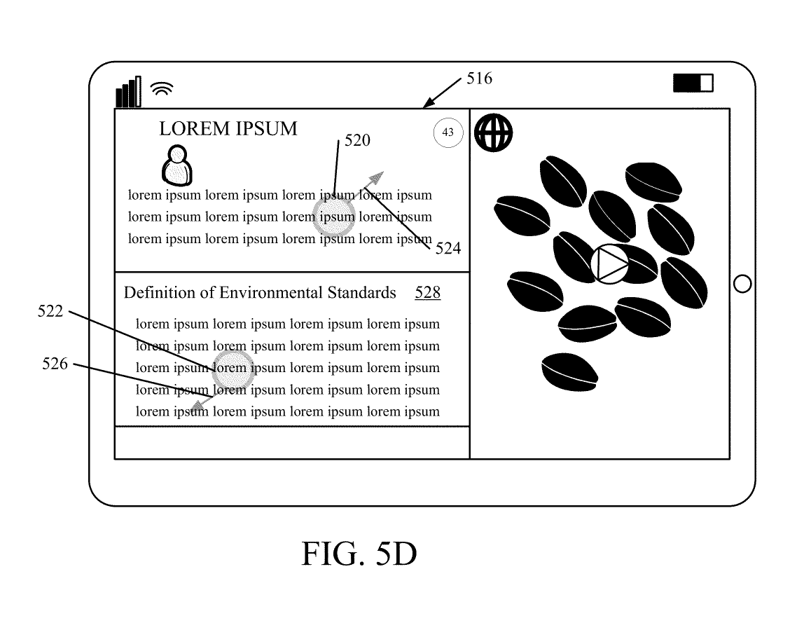

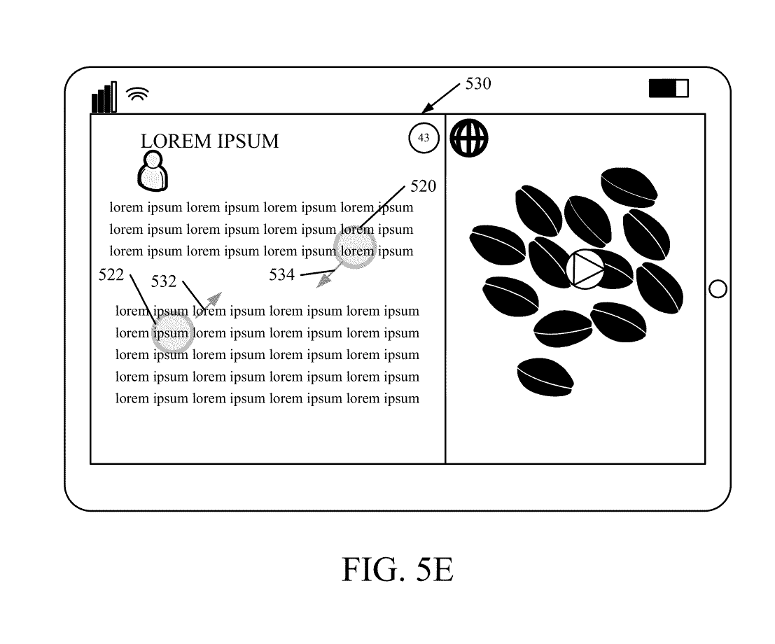

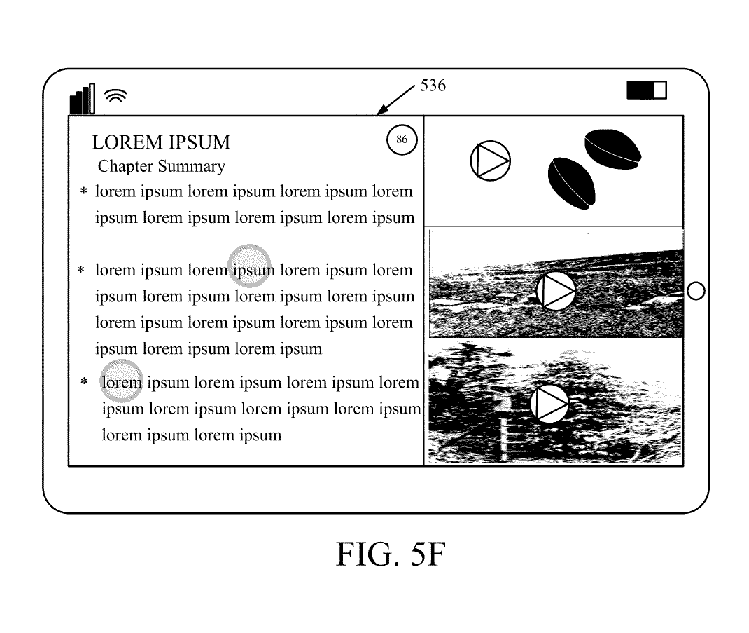

FIGS. 5-5F show various embodiments in which consumption time manger 170 can use detail manger 172 to expand or contract the level of detail in an item of content to match the desired consumption time. It will also be noted that user 106 can use detail manager 172 independent of consumption time manger 170, to manually invoke manager 172 to expand or contract the level of detail in an item of content that is being consumed.

FIG. 5 is a block diagram illustrating one embodiment of detail manager 172 in more detail. It can be seen that detail manger 172 illustratively includes detail adjustment component 480 and reading level adjustment component 482. FIG. 5A is a flow diagram illustrating one embodiment of the overall operation of detail manger 172.

In one embodiment, detail manager 172 can optionally, automatically adjust the level of detail corresponding to a given item of content, before it is presented to user 106, based upon the users reading level. Reading level 484 can be input by the user along with profile information, or otherwise, or it can be implicitly determined by detail manger 172 or another component of system 102. For instance, component 172 can use content analyzer 176, as discussed above, to identify keywords in the content that has already been consumed by user 106 and correlate those to a reading level. There are a wide variety of other ways for determining reading level as well and those are contemplated herein. Optionally obtaining the reading level (either calculated or expressed) is indicated by block 486 in FIG. 5A.

The user can also manipulate the level of detail by providing a suitable user input in order to do this. Receiving the detail level user input 488 is indicated by block 490 in FIG. 5A. The user can provide this user input in a number of different ways. For instance, the user can provide a slider input 492 or a discrete selection input 494 to select a detail level to provide slider input 492, the user can illustratively move a slider on the user interface display to see more detail or less detail on the presented item of content. The discrete selection input 494 allows the user to discretely select a level of detail. The user can also illustratively provide a touch gesture 496 (such as a pinch or spread gesture) to telescope the text to either display more detail or less detail. Of course, the user can provide other inputs to select a detail level as well, and this is indicated by block 498. A number of these user input mechanisms are described below with respect to FIGS. 5B-5F.

In any case, once the level of detail user inputs have been received (and optionally the user's reading level), detail adjustment component 480 adjusts the level of detail of the items of content 489 so that they are adjusted to a desired level based upon the various inputs. Reading level adjustment component 482 (where the reading level is to be considered) also makes adjustment to the items of content 489 based on the user's reading level. The adjusted items of content 500 are output by detail manger 172. Adjusting the items of content is indicated by block 502 in FIG. 5A, outputting the adjusted items of content is indicated by block 504, and determining whether the user wishes to adjust the level of detail further is indicated by block 506. If the user does adjust the level of detail further, then processing returns to block 490. If not, the item of content is output at the selected detail level. FIGS. 5B-5F show various ways that a user can modify the level of detail displayed in the items of content being consumed.

FIG. 5B shows a user interface display 508 that has a discrete selector user input mechanism 510. The user can move slider 512 along an axis 514 to select one of four discrete levels of detail. Those shown in user interface display 508 include “summary”, “abridged”, “normal”, and “detailed”. As the user moves slider 512 along axis 514, detail manger 172 uses any other desired components in system 102 and automatically adjusts the level of detail for the displayed text and displays it according to the newly selected level of detail.

FIGS. 5C-5F show how a user may select the level of detail using touch gestures (such as pinch and spread gestures). FIG. 5C shows one example of a user interface display 516 that displays text 518. The user illustratively places his or her fingers around a group of text. The users fingers are represented by circles 520 and 522. The item of text is “environmental standards” in textual portion 518. The user then moves his or her fingers in a spreading direction as indicated by arrows 524 and 526. This causes detail manger 172 to increase the level of detail, and specifically provide a definition for the item of text around which the user had placed his or her fingers. FIG. 5D shows one embodiment of the user interface display 516 after the user has used the spread gesture described above with respect to FIG. 5C. It can be seen that detail manger 172 has inserted a detailed explanation of (or definition of) “environmental standards” in detail section 528. Detail manger 172 has increased the level of detail of the display based on the user input gestures.

FIG. 5E is another embodiment in which user 106 wishes to contract the level of detail so that the display includes less detail. In the user interface display 530 of FIG. 5E, the user has placed his or her fingers 522 further apart and uses a pinch gesture by moving them in the direction indicated by arrows 532 and 534. This causes detail manger 172 to reduce the amount of detail in the display. In the embodiment illustrated, detail manger 172 uses summarization component 178 to either summarize the content on the display, or it accesses preexisting summaries 194, and displays those summaries in place of the content.

FIG. 5F shows one example of a user interface display 536 where detail manger 172 has reduced the level of detail from that in display 530 of FIG. 5E. It can be seen that now only a chapter summary is displayed, instead of the entire chapter in textual form. Based upon the user's inputs, detail manger 172 automatically changes the level of detail in displayed content, and reflows the text so that it is displayed at the desired level of detail.

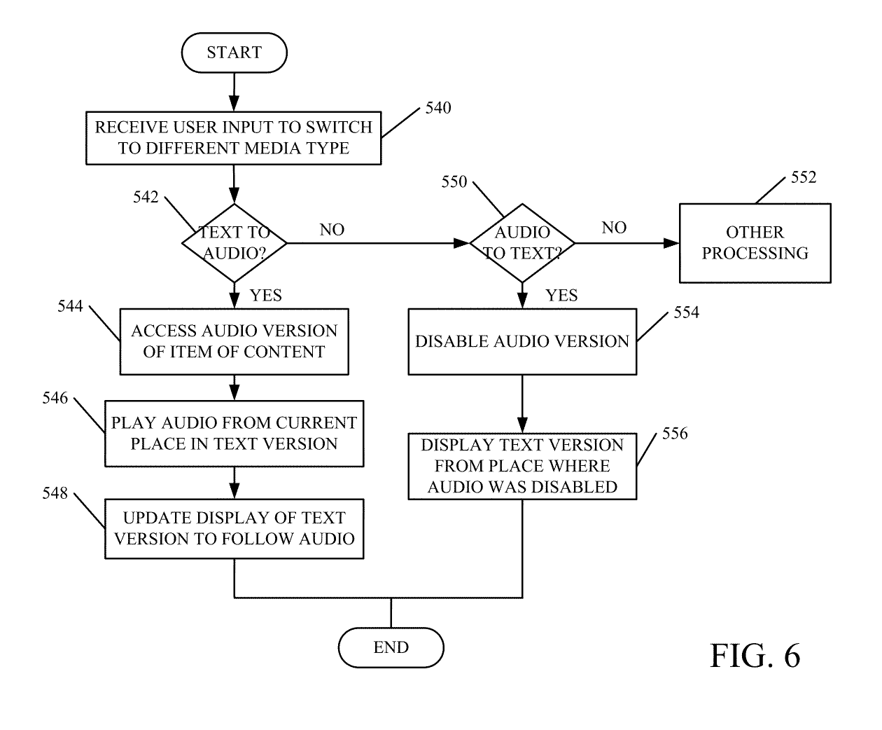

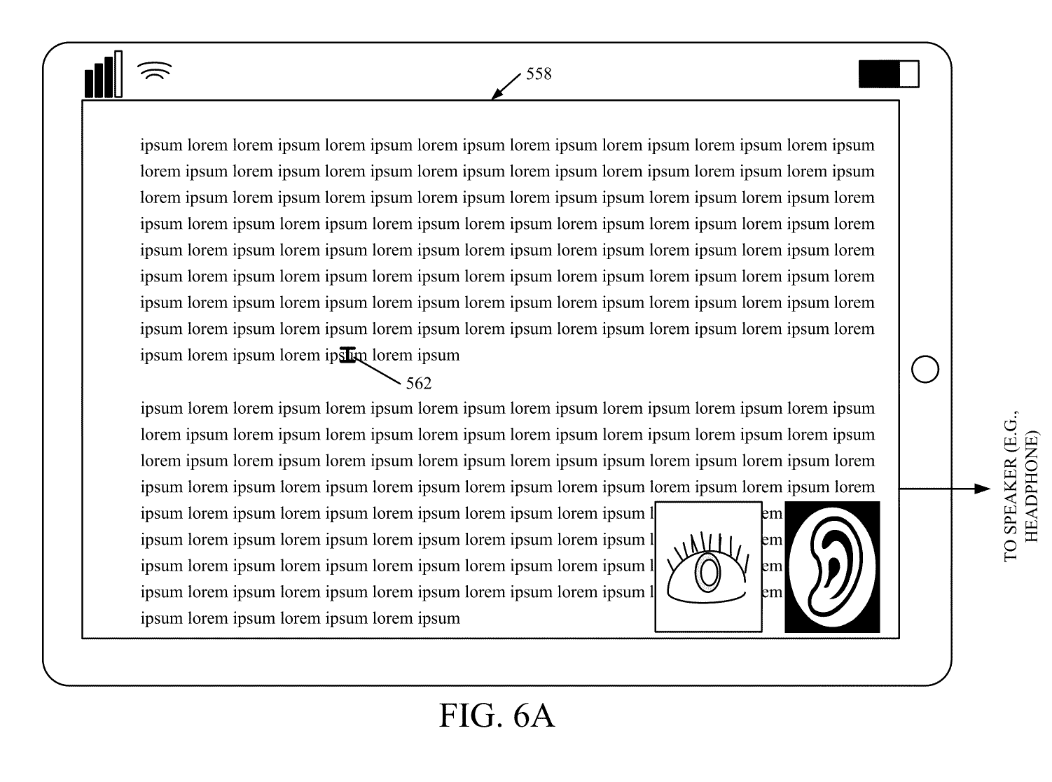

FIG. 6 is a flow diagram illustrating one embodiment of the operation of media manager 174. Media manger 174 can be used where user 106 wishes to switch between consuming content in one media type to consuming it in another media type. For instance, where the user is reading text, but wishes to switch to listening to an audio recording of the text, the user can use media manger 174 to do this.

FIG. 6 shows that in one embodiment, user 106 is consuming content, and media manger 174 receives a user input to switch to a different media type. This is indicated by block 540 in FIG. 6. If the user is switching from text to audio (as indicated by block 542), then media manager 174 accesses an audio version of the item of content being consumed by user 106. This is indicated by block 544. Media manger 174 then plays the audio, beginning from the current place in the text version that the user has left off. This is indicated by block 546. Media manger 174 illustratively continues to update the display of the textual representation to show the place in the text where the audio version is currently reading from. Following the audio version in the textual representation is indicated by block 548.

If, at block 542, it is determined that the user is not switching from text to audio, then it is determined whether the user is switching from audio to text at block 550. If not, then some other processing is performed at block 552. However, if the user is switching from an audio version to a text version, then media manager 174 disables the audio version as indicated by block 554 and displays the text version beginning from the place where the audio version was disabled. This is indicated by block 556.

FIG. 6A shows one embodiment of a user interface display 558 that illustrates this. User interface display 558 shows text that corresponds to an item of content being read by the user. The user can switch from a text version to an audio version by providing a suitable user input on a user input mechanism. In the embodiment shown in FIG. 6A, the user simply touches the icon 650 representing the audio version. Media manger 174 then access the audio version of the text and begins playing it by sending it to speakers (such as headphones). At the same time, media manger 174 updates the visual display so that the cursor 562 follows the audio version, on the textual display. If the user wishes to switch back from the audio version to the textual version. The user provides another suitable input, such as by actuating icon 564 that represents the textual version.

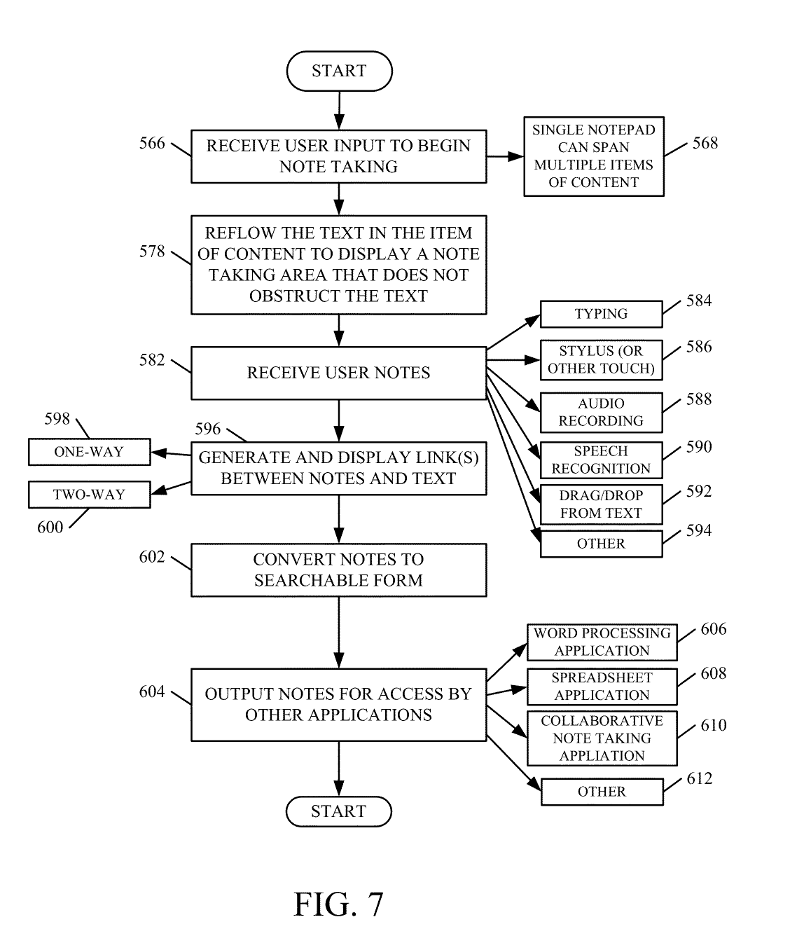

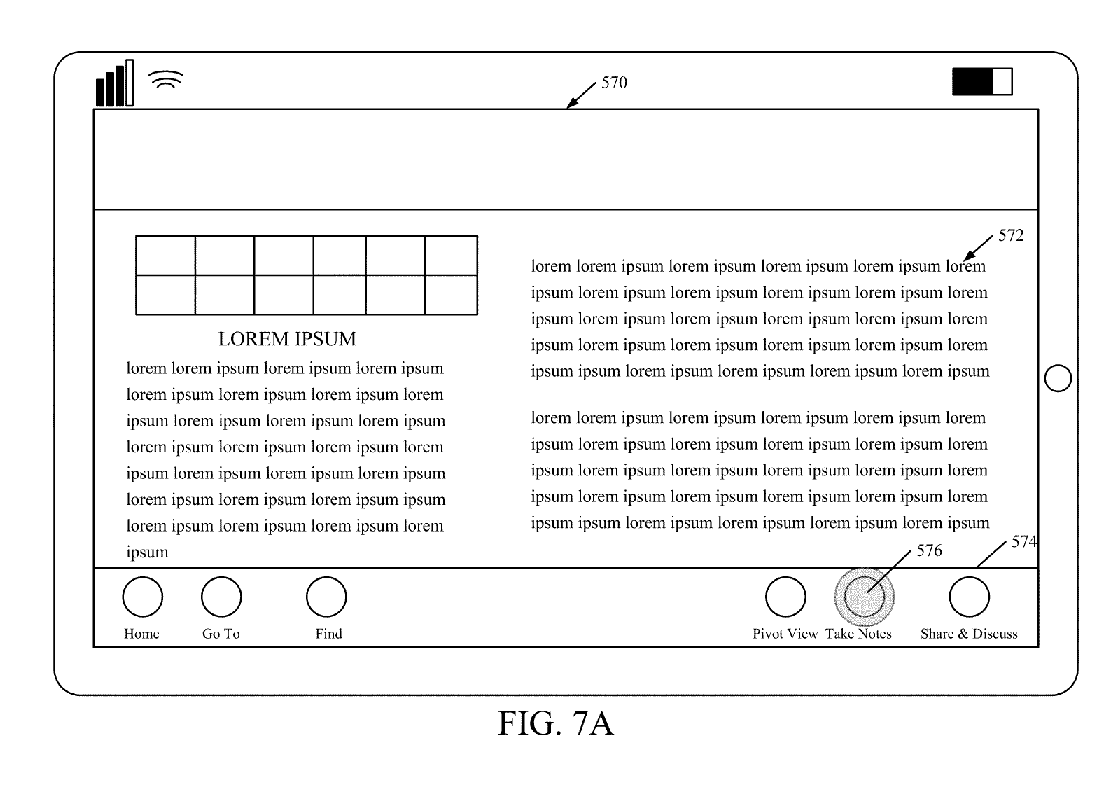

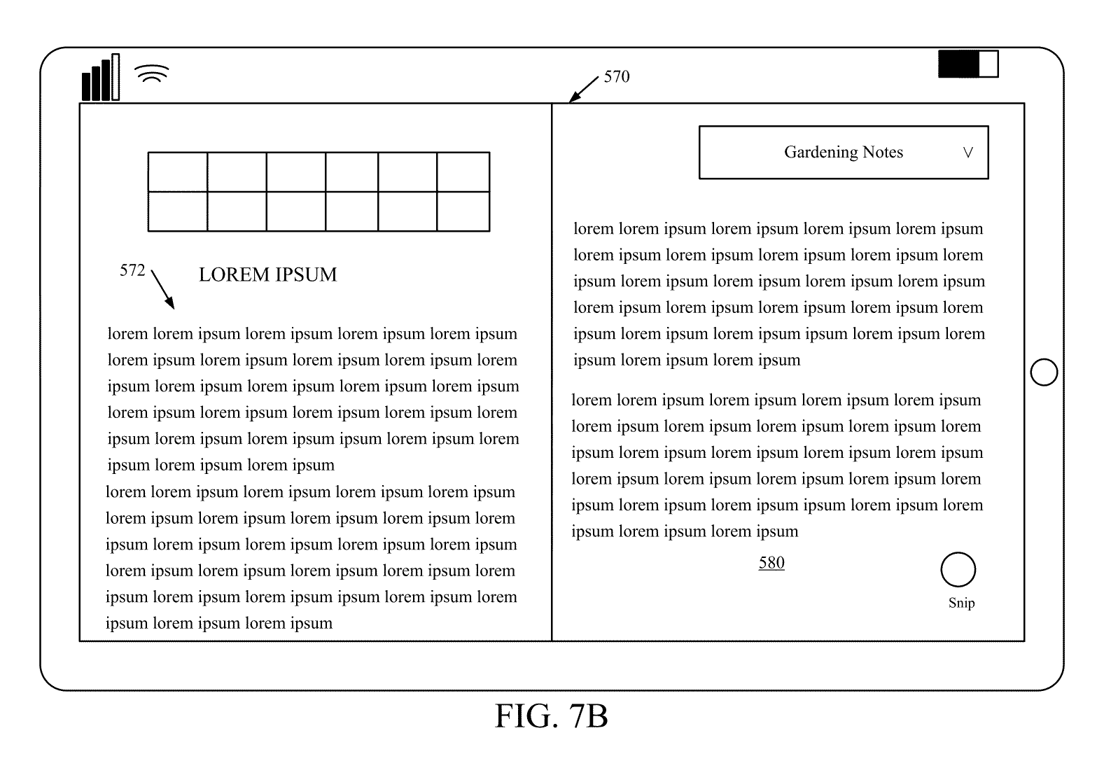

FIG. 7 shows one embodiment of a flow diagram illustrating the operation of note taking component 184 in more detail. In the embodiment illustrated, note taking component 184 can use various other components of system 102 to enable a user to take notes corresponding to one or more pieces of content. Note taking component 184 first receives a user input that indicates the user wishes to begin to take notes. This is indicated by block 566 in FIG. 7. It should be noted that a single note pad can span multiple items of content, or multiple notepads can correspond to a single item of content as well. This is indicated by block 568.

FIG. 7A shows one embodiment of a user interface display 570 that illustrates this. It can be seen in FIG. 7A that an item of content is generally displayed at 572. The user has invoked a tool bar 574 and has actuated button 576 indicating that the user wishes to take notes.

In response, note taking component 184 illustratively reflows the text 572 in the item of content to display a note taking area that does not obstruct the text 572. This is indicated by block 578 in FIG. 7.

FIG. 7B shows one embodiment of user interface display 570 that exposes a note taking pane 580 where the user can take notes without obstructing the view of text 572. It should be noted that text 572 and notes 580 can be independently scrollable and searchable by the user. In one embodiment, such as when text 572 is in the 2-column format, text 572 does not need to be re-flowed in order to expose note taking pane 580. That way the user will not lose their place in the text. If the text 572 were in a different format—for example the scrolling continuous format, then it would reflow to allow for the note taking pane 580 to be visible without obscuring the text 572.

In any case, note taking component 184 then receives user inputs indicative of notes being taken. This is indicated by block 582 in FIG. 7. The user can provide these inputs to take notes in a wide variety of different ways, such as by typing 584, using a stylus (or other touch gesture 586, invoking an audio recording device to record the user's speech 588, dictating notes by using speech recognition component 180 (as is indicated by block 590), or to drag and drop certain items of text from text 572 to notes 580 or vice versa. This is indicated by block 592. Of course, the user can take notes in other ways as well, as indicated by block 594.

In one embodiment, the user can also insert links linking notes 580 to text 572. In that case, the links will appear in notes 580 and, when actuated by the user, will navigate the user in text 572 to the place in the text where the notes were taken. Similarly, the user can generate links linking text 572 to notes 580 in the same way. Then, when the user is reading text 572 and actuates one of the links, notes display 580 is updated to the place where the corresponding notes are displayed. Generating and displaying links between the notes and text is indicated by block 596. Generating them one way (from text to notes or notes to text) is indicated by block 598 and generating them in both directions is indicated by block 600.

In one embodiment, note taking component 184 also illustratively converts the notes 580 into searchable form. This is indicated by block 602 in FIG. 7.

The notes 580 can then be output for access by other applications as indicated by block 604. For instance, they can be output in a format accessible by a word processing application 606, a spread sheet application 608, a collaborative note taking application 610, or any of a wide variety of other applications 612.

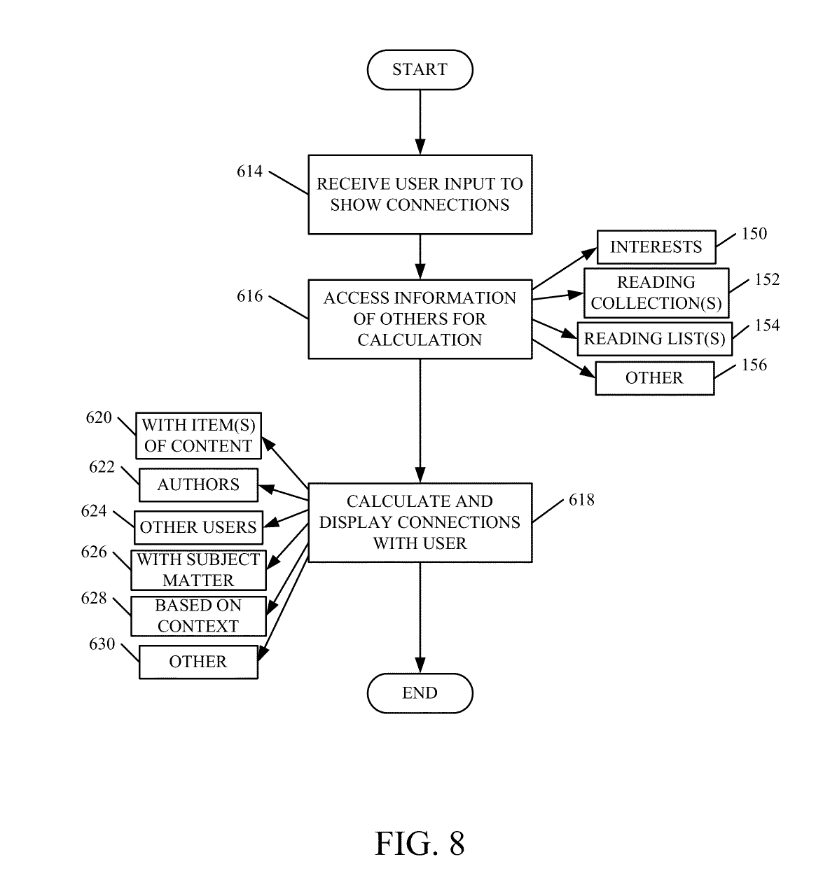

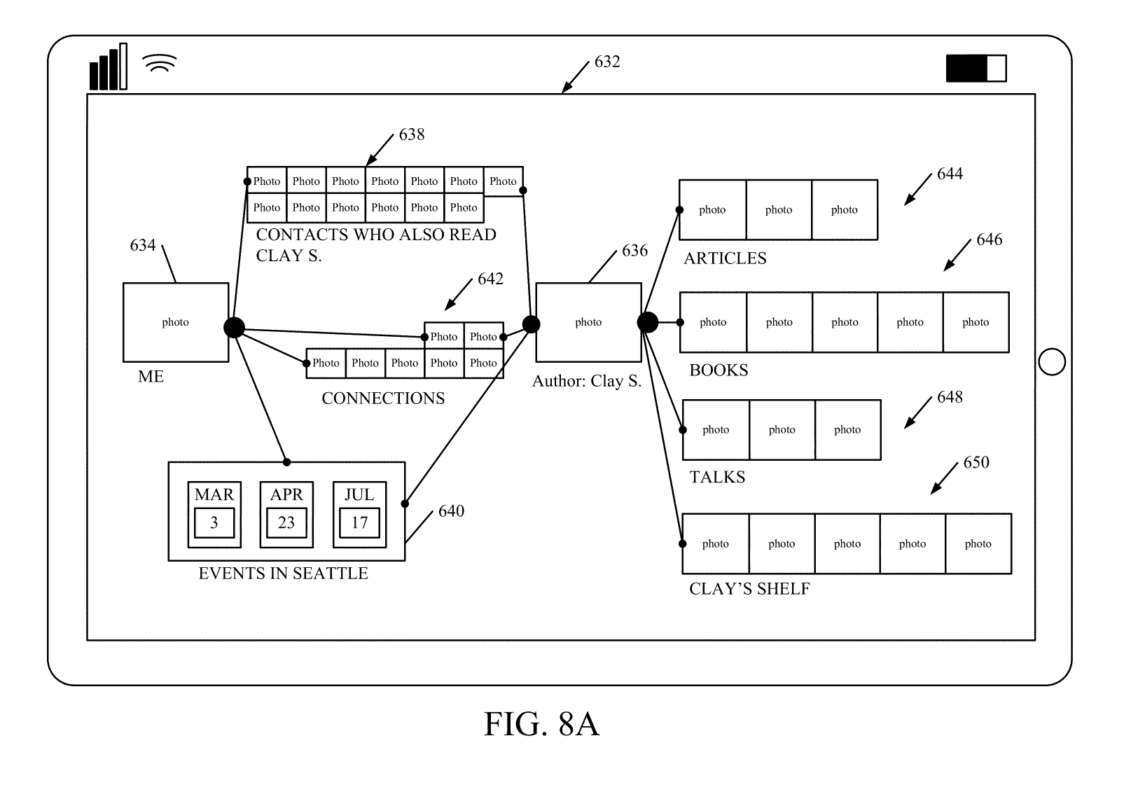

FIG. 8 is a flow diagram illustrating one embodiment of the operation of generator 130 in generating various connections 156 (shown in FIG. 1). The connections can be between user 106 and other users, between the user 106 and authors, subject matter areas, or between the user and other items related to the content or interests of the user. In one embodiment, connection generator 130 receives a user input to show connections related to the user. This is indicated by block 614 in FIG. 8. Connection generator 130 then accesses other information to calculate connections. This is indicated by block 616. For instance, generator 130 can access the user's interests 158 or the user's reading collections reading lists 152 and 154, respectively. Of course, the user can also access other information as indicated by block 156, such as the user's social graph, the social network sites of others in the user's social graph, information such as collections or reading lists from other users that share the same interests as user 106, or a wide variety of other information. Connection generator 130 then calculates and displays connections that user 106 has with other items. This is indicated by block 618 in FIG. 8. The connections can be with various items of content 620, with authors 622, with other users 624, with subject matter areas (such as the user's interests or subject matter related to the user's interests 626), they can be based on certain context information 628, or they can be other connections 630 as well.

FIG. 8A shows one embodiment of a user interface display 632 showing various connections. For instance, user interface display 632 shows a visual representation 634 of the user. User interface display 632 also shows other contacts of the user which have read items by a given author 636. Those individuals are represented by their images or in other ways, generally shown at 638. User interface display 632 also shows that the author 636 is speaking in the geographic area of user 634, and this connection (based on location context) is indicated by block 640 in user interface display 632. Display 632 also shows various other connections 642 that user 106 has with author 636. Each connection is represented in display 632 by an image or photo, but it can be represented in a wide variety of other ways as well. For instance, the connections at 642 can be shared subject matter interests, shared areas of expertise, etc.

User interface display 632 also shows items generated by author 636 (to which the user 106 is connected). In the example shown in FIG. 8A, those items include articles 644 written by author 636, books 646, talks 648 presented by author 646, and the reading list or collection 650 of author 636.

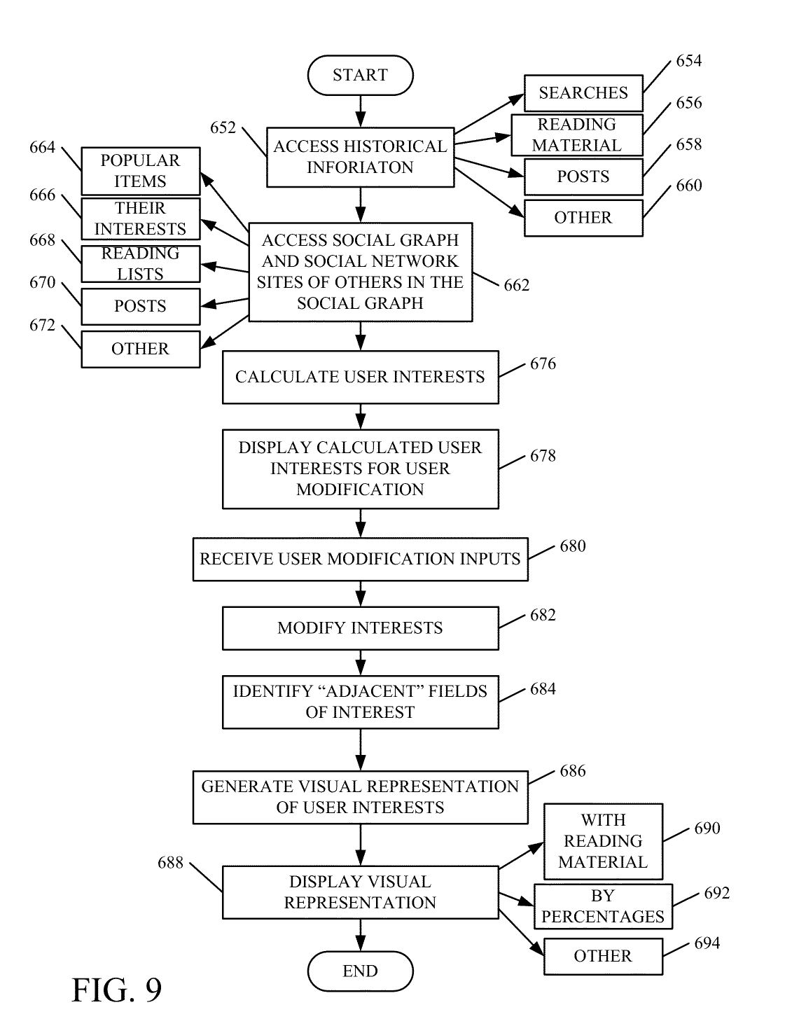

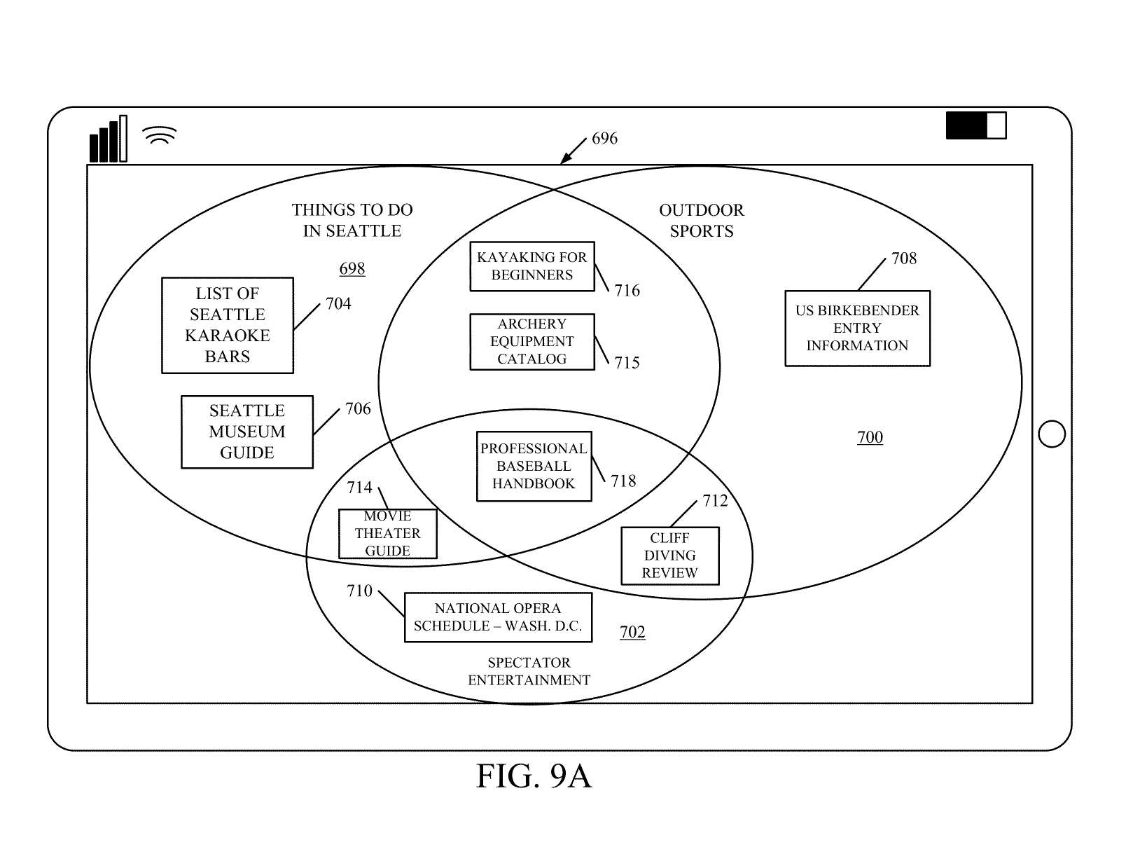

FIG. 9 is a flow diagram illustrating one embodiment of the operation of interest calculation component 138 that is used to calculate the interests of user 106, or other users that may be connected to user 106. In one embodiment, component 138 first accesses historical information of user 106. This is indicated by block 652. Of course, the historical information can be searches 654 conducted by user 106, reading materials 656 read by user 106, posts 658 that are posted by user 106 on the user's social network site, or a wide variety of other information 660.

Interest calculation component 138 also illustratively accesses the social graph and social network sites of others in the user's social graph. This is indicated by block 662. For instance, component 138 can access the other user's popular items 664, their interests 666, their reading lists 668, or their posts 670. Component 138 can also access other information 672 about other users in the user's social graph. Based on these (or other inputs) interest calculation component 138 calculates the user's interests, as indicated by block 674 in FIG. 9. The calculated interests are then displayed for user modification as indicated by block 678.

As discussed above, it may be that the user wishes to provide a different public perception than the one generated by interest calculation component 138. For instance, if the user has just begun using the system, the data used by component 138 may be incomplete. Also, the user may wish to keep some interests private. Therefore, the calculated interests are displayed for user modification. Receiving user inputs modifying the interests is indicated by block 680, and modifying the interests that are to be displayed (based on those inputs) is indicated by block 682.

In one embodiment, interest calculation component 138 also identifies adjacent fields of interest as indicated by block 684. For instance, there may be subtopics of an area of interest that the user 106 is unaware of. In addition, there may be closely related subject matter areas that the user is unaware of. Interest calculation component 138 illustratively surfaces these areas and displays them for user consideration.

Component 138 then generates a visual representation of the user interests as indicated by block 686, and displays that representation as indicated by block 688. The representation can include the reading material that the user 106 has read and that corresponds to each calculated area of interest. This is indicated by block 690. The display can also include the percentages of material that are read by the use in each calculated area of interest. This is indicated by block 692. Of course, the interests can be displayed in other ways as well, and this is indicted by block 694.

FIG. 9A shows one embodiment of a user interface display 696 showing the user's interests in Venn diagram form. It can be seen that the Venn diagram display includes three areas of interest. The first is “Things to do in Seattle” represented by circle 698. The second is “Outdoor Sports” indicated by circle 700, and the third is “Spectator Entertainment” indicated by block 702. It can be seen that the reading material read by user 106 and related to each of the areas of interest are plotted on the Venn diagram. Some items that have been read by the user (such as items 704 and 706) only correspond to the subject matter of interest represented by circle 698. Others, such as item 708 correspond only to the subject matter of interest represented by circle 700 and another 710 corresponds only to the subject matter of interest represented by circle 702. However, item 712 is shared by the subject matters of interest represented by circles 700 and 702 and item 714 is shared by circles 698 and 702. Items 715 and 716 are shared by subject matters of interest in circles 698 and 700 and item 718 is shared by all three circles. Of course, there are a wide variety of other ways for displaying user's interests and that shown in FIG. 9A is only one example.

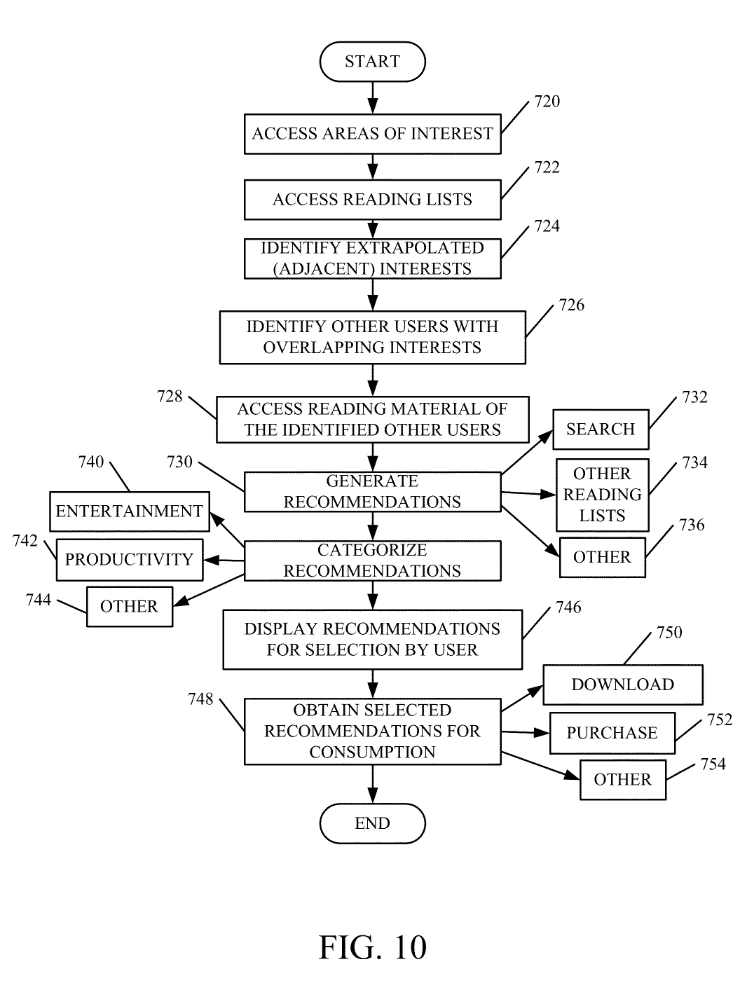

FIG. 10 is a flow diagram illustrating one embodiment of the operation of recommendation component 134 recommending new items of reading material for user 106. Component 134 first accesses the areas of interest 158 (both calculated and expressed) for user 106. This is indicated by block 720 in FIG. 10. Component 132 also accesses the reading lists 154. This is indicated by block 722. Component 134 then identifies extrapolated (or adjacent) areas of interest that may have already been calculated by interest calculation component 138. This is indicated by block 724 in FIG. 10.

Component 134 can also identify other users with overlapping interests (or connected by common subject matter areas of interest) with user 106. This is indicated by block 726 in FIG. 10. Component 134 then accesses the reading material of the identified other users as indicated by block 728 and generates recommendations in all of the information accessed. This is indicated by block 730 in FIG. 10. Component 134 can do this in a number of ways. For instance, it can search over network 122 for other content items to recommend to the user. This is indicated by block 732. It can also identify items on the reading lists or on the collections of other users as indicated by block 734. Of course, it can identify other recommended reading material in other ways as well and this is indicated by block 736.

Recommendation component 134 then illustratively categorizes the recommendations based on a number of different categories that can be predefined, calculated dynamically or set up by the user, or all of these. Categorizing the recommendations is indicated by block 738. In one embodiment, component 134 categorizes the recommendations into an entertainment category 740, a productivity category 742 and any of a wide variety of other categories 744. Component 134 then displays the recommendations for selection by the user 106, and this is indicated by block 746 in FIG. 10.

The user then illustratively selects from among the recommendations for items to consume. This is indicated by block 748. The user can do this using a suitable user input mechanism such as by clicking on one of the recommendations, or selecting it in a different way. Component 134 then uses content collection component 140 to obtain the selected item of content in a variety of different ways. For instance, it can download the item as indicated by block 750. It can purchase the item as indicated by block 752 or it can obtain the item in another way as indicated by block 754. In one embodiment, the collected content items show up in the user's reading list 154 and collection 152. They can be displayed such that purchased items are indistinguishable from one another or they can be distinguished visually.

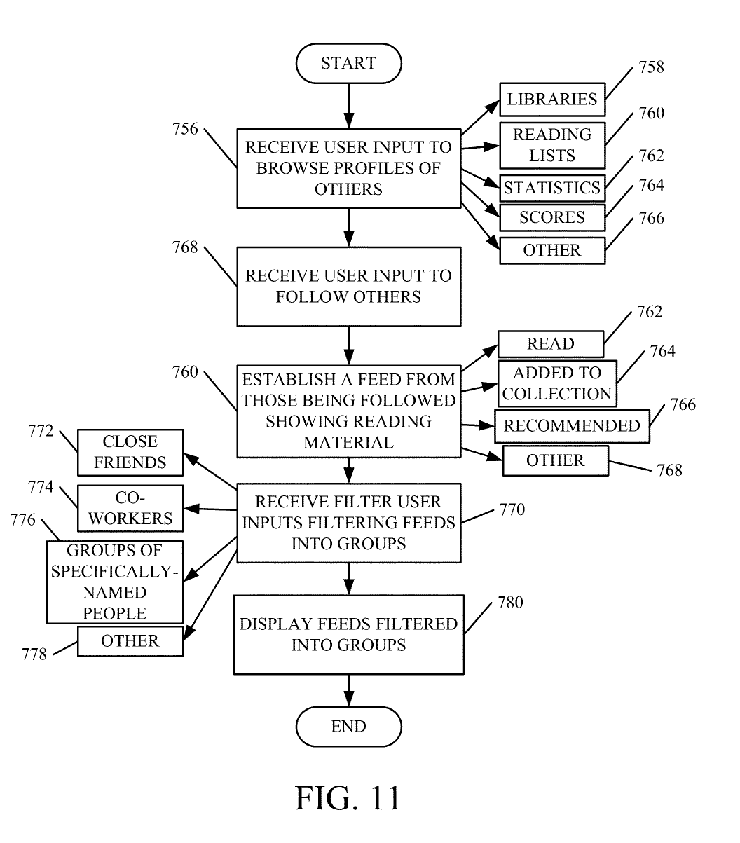

FIG. 11 is a flow diagram illustrating one embodiment of the operation of social browser 144 in more detail. Browser 144 illustratively allows a user to browse the sites of other users of the system. Therefore, social browser 144 first receives user input to browse the profiles of other users. This is indicated by block 756 in FIG. 11. The user can look at other users' libraries 758, reading lists 760, statistics 762, reading comprehension scores or other calculated scores 764 and biographical or other information 766. The social browser 144 also provides a user input mechanism that can be actuated by user 146 in order to follow another user. Receiving the user input to follow another user is indicated by block 768 in FIG. 11.

Social browser 144 then establishes a feed from those being followed by user 106, showing their reading material. This is indicated by block 760 in FIG. 11. The feed can include the items actually read 762 by the person being followed, the items newly added to the collection 764 of the person being followed, the items recommended 766 by the person being followed, or other information 768.

In one embodiment, user 106 can also filter the feeds from those he or she is following by providing filter inputs through a suitable user input mechanism. Receiving filter user inputs filtering the feeds into groups is indicated by block 770 in FIG. 11. For instance, the user can filter the feeds to be grouped into feeds by close friends 772, by co-workers 774, by groups of specifically-named people 776, or other groups 778.

Social browser 144 then displays the feeds filtered into the groups. This is indicated by block 780. Social browser 144 can incorporate these feeds into the dashboard view generated by dashboard generator 124, or using a separate view, or in other ways as well.

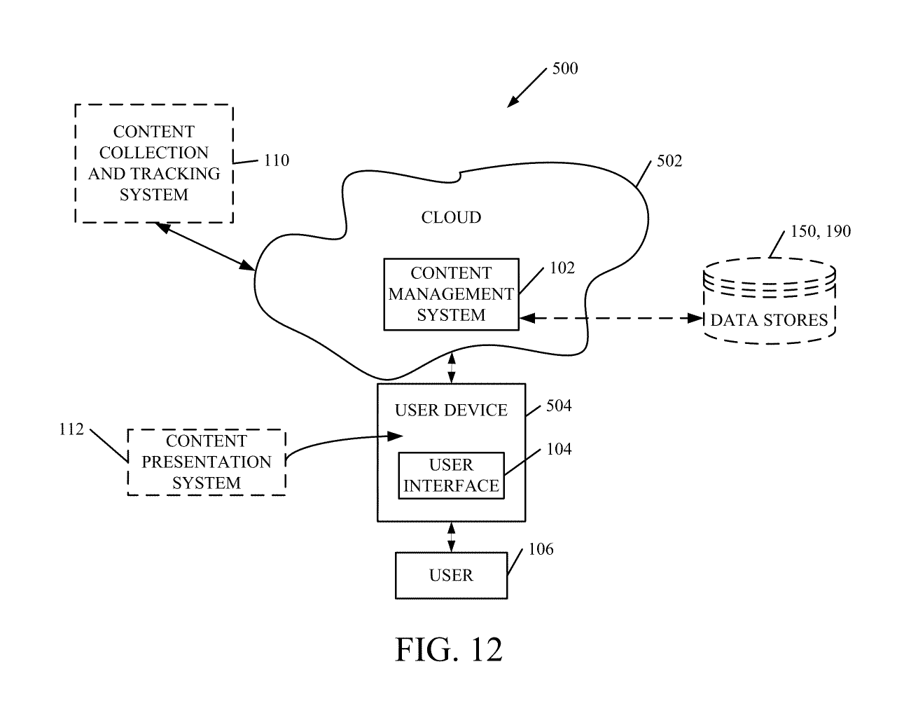

FIG. 12 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 12, some items are similar to those shown in FIG. 1 and they are similarly numbered. FIG. 12 specifically shows that system 102 is located in cloud 502 (which can be public, private, or a combination where portions are public while others are private). Therefore, user 106 uses a user device 504 to access those systems through cloud 502.

FIG. 12 also depicts another embodiment of a cloud architecture. FIG. 12 shows that it is also contemplated that some elements of system 102 are disposed in cloud 502 while others are not. By way of example, data stores 150, 190 can be disposed outside of cloud 502, and accessed through cloud 502. In another embodiment, content collection and tracking system 110 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. FIG. 12 also shows that some or all of system 102 can be located on user device 504 as well. For example, FIG. 12 shows that content presentation system 112 can be located on device 504 but other systems could as well. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

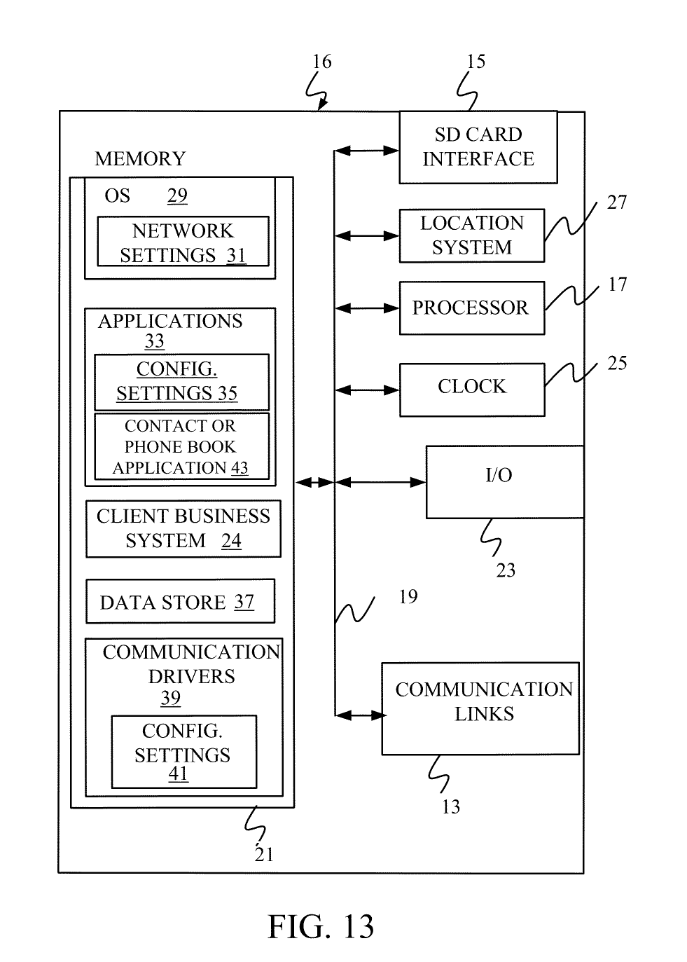

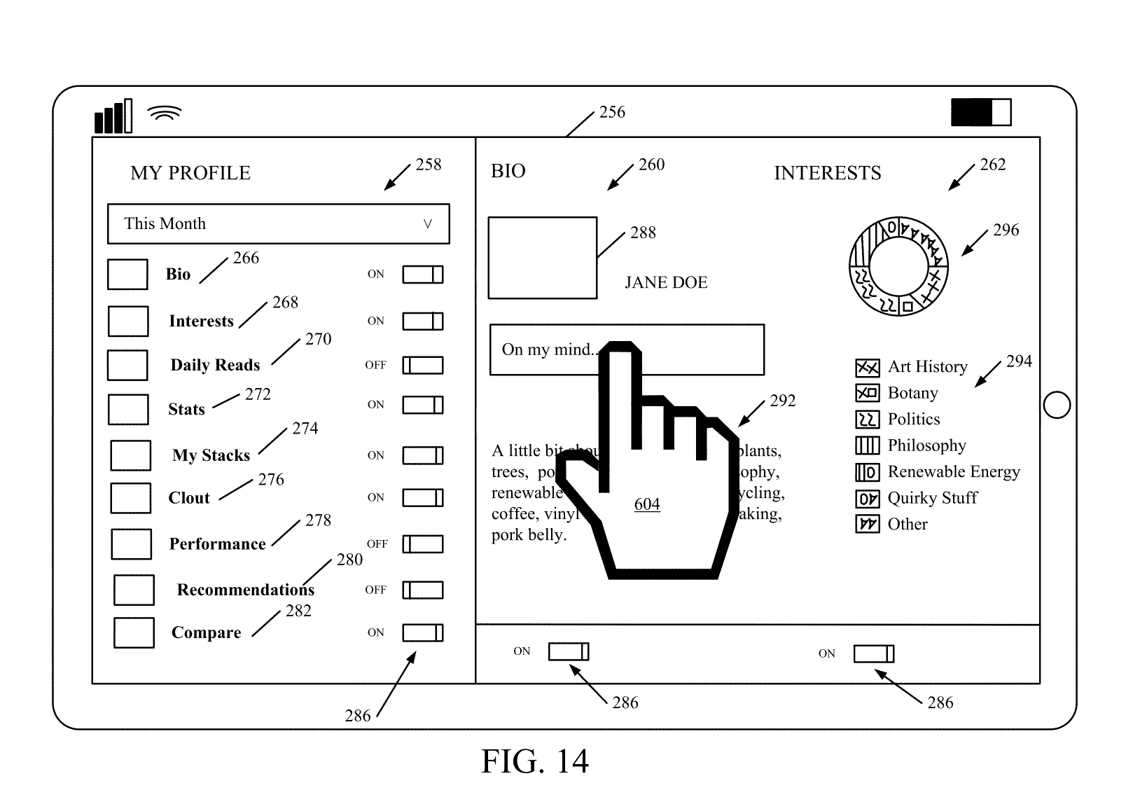

FIG. 13 is a simplified block diagram of one illustrative embodiment of a handheld or mobile computing device that can be used as a user's or client's hand held device 16, in which the present system (or parts of it) can be deployed. FIGS. 14-18 are examples of handheld or mobile devices.

FIG. 13 provides a general block diagram of the components of a client device 16 that can run components of system 102 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 146 or 186 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Application 154 or the items in data store 156, for example, can reside in memory 21. Similarly, device 16 can have a client business system 24 which can run various business applications or embody parts system 102. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 14 shows one embodiment in which device 16 is a tablet computer 600. In FIG. 14, computer 600 is shown with user interface display from FIG. 2D displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

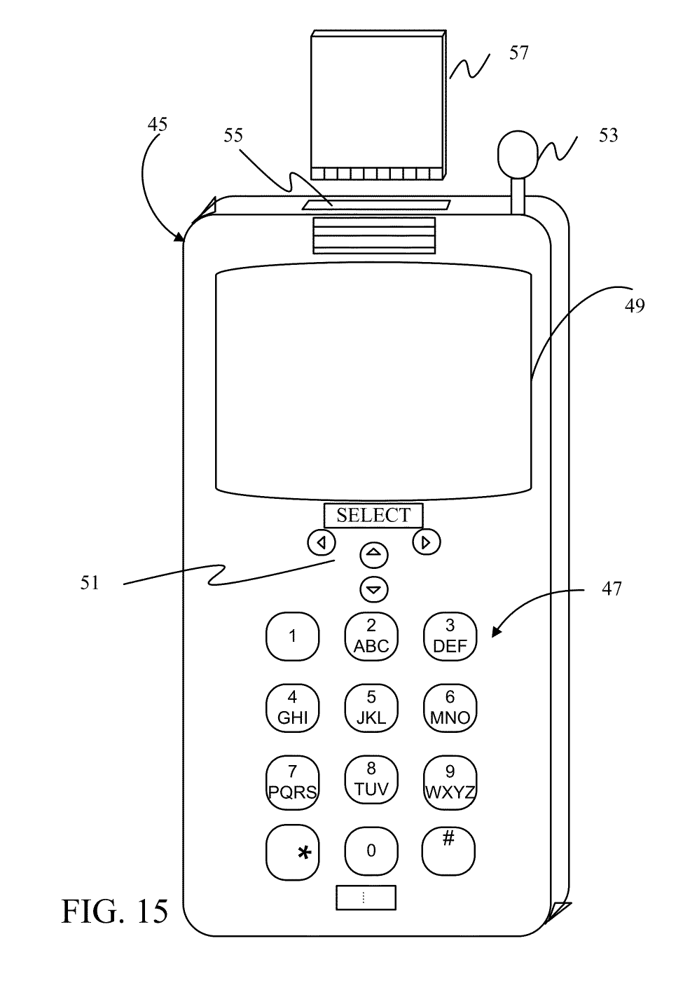

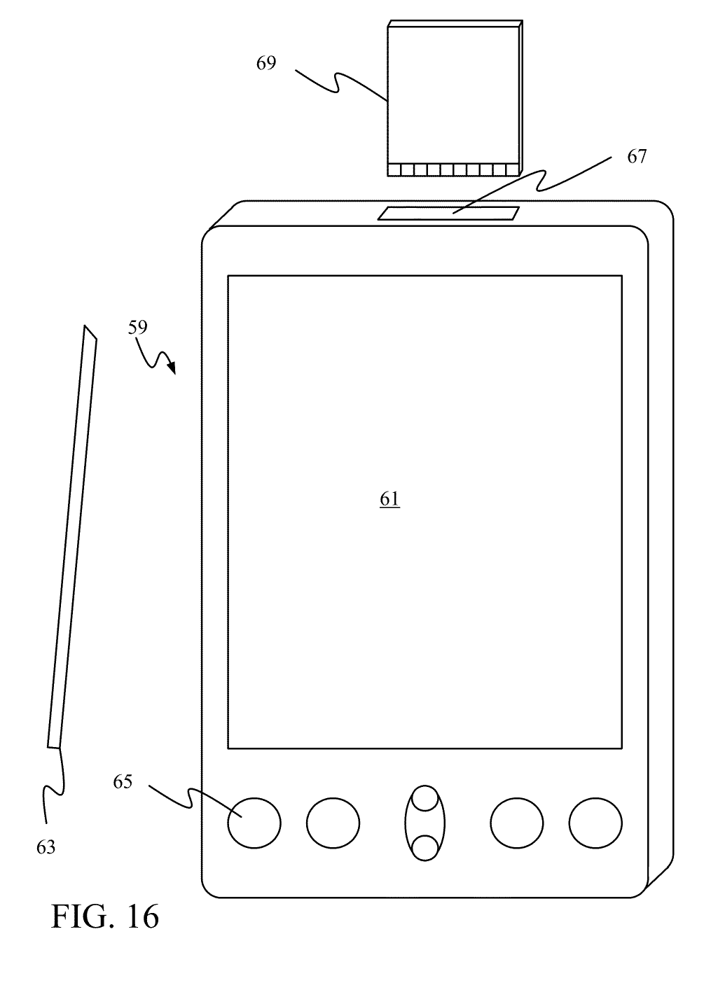

FIGS. 15 and 16 provide additional examples of devices 16 that can be used, although others can be used as well. In FIG. 15, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 16 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

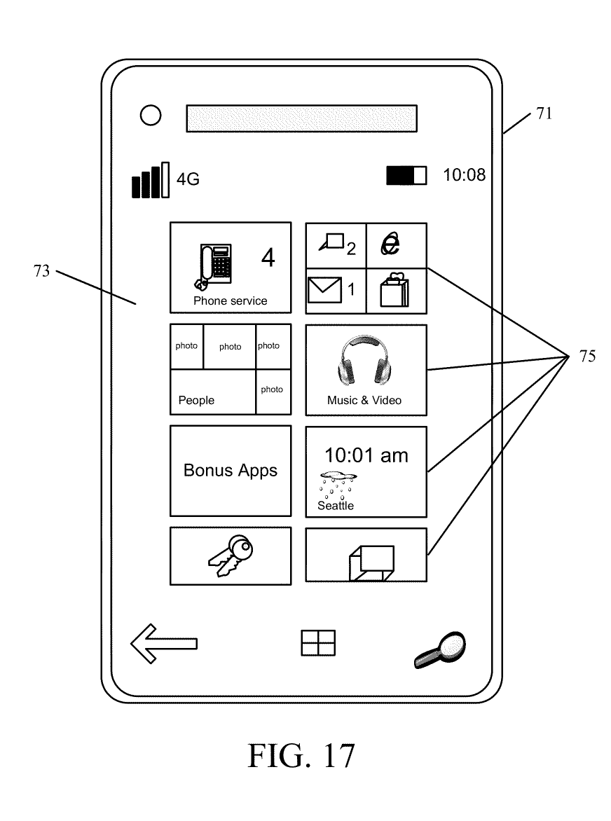

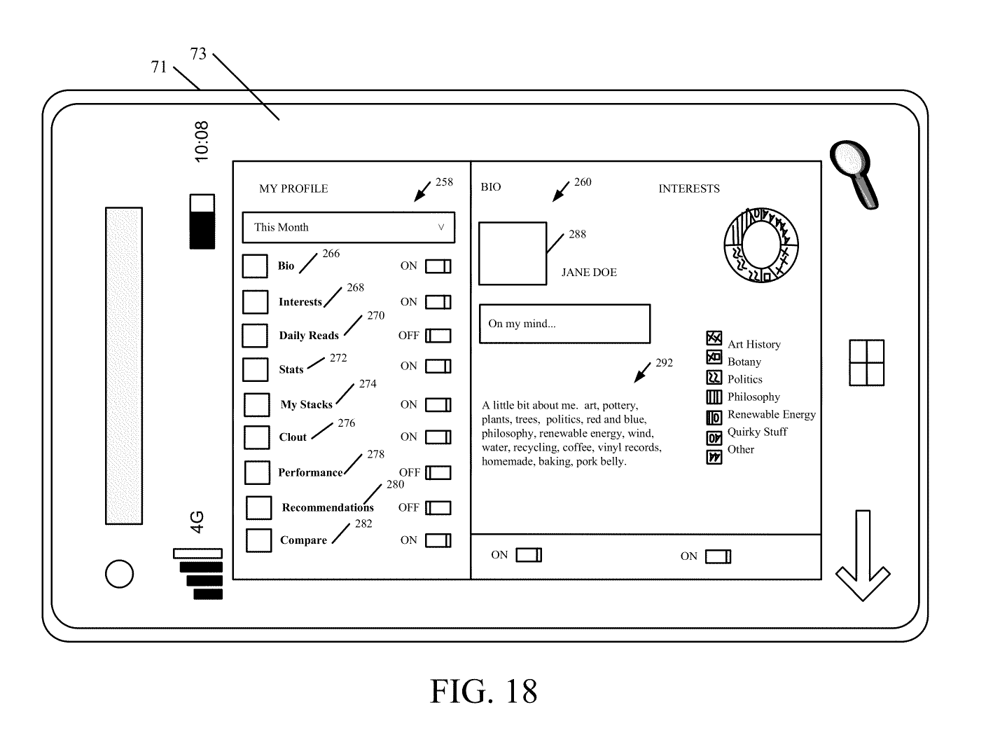

FIG. 17 is similar to FIG. 15 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 18 shows smart phone 71 with the user interface of FIG. 2D on display 73

Note that other forms of the devices 16 are possible.

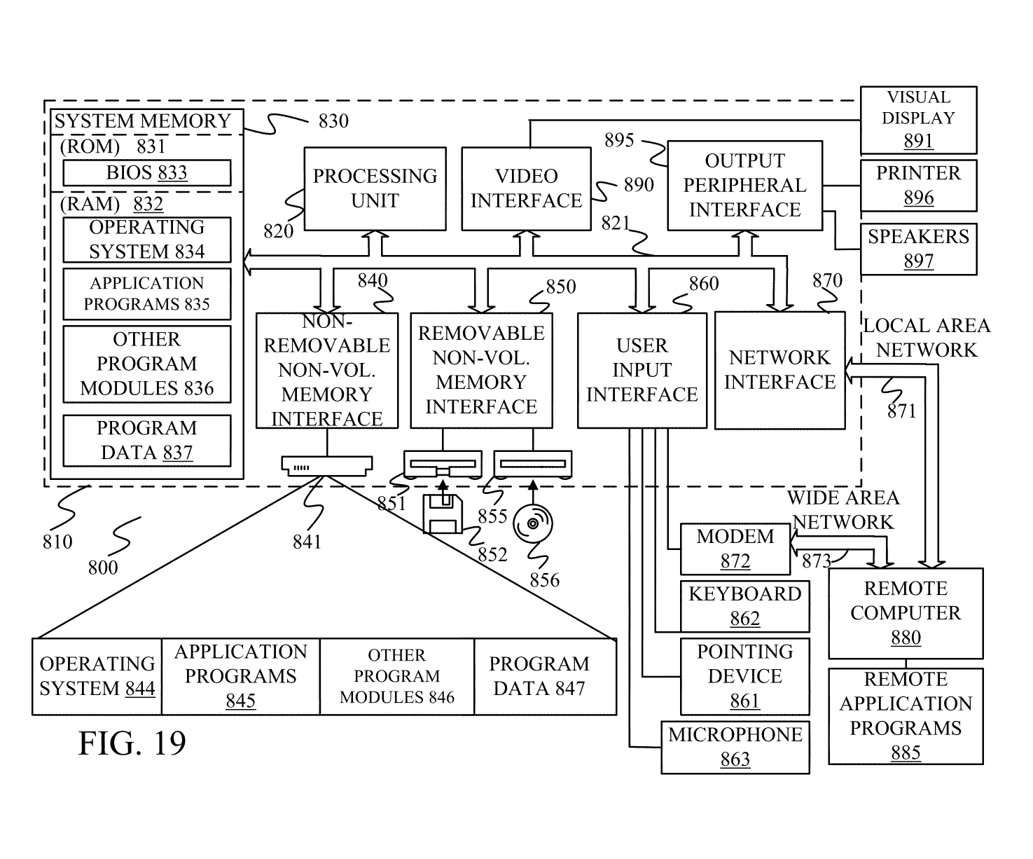

FIG. 19 is one embodiment of a computing environment in which architecture 100, or parts of it, (for example) can be deployed. With reference to FIG. 19, an exemplary system for implementing some embodiments includes a general-purpose computing device in the form of a computer 810. Components of computer 810 may include, but are not limited to, a processing unit 820 (which can comprise processor 146 or 186), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 19.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 19 illustrates operating system 834, application programs 835, other program modules 836, and program data 837.

The computer 810 may also include other removable/non-removable volatile/nonvolatile computer storage media. By way of example only, FIG. 19 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 19, provide storage of computer readable instructions, data structures, program modules and other data for the computer 810. In FIG. 19, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 19 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 19 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of generating a presentation of an item of content from a content collection, the method comprising:
displaying the item of content, including a first content type and a second content type, on a user interface display according to a content type mix, the content type mix defining a first content type display portion corresponding to a portion of the user interface display used to display the first content type and a second content type display portion corresponding to a portion of the user interface display used to display the second content type;
displaying a user input mechanism on the user interface display to receive a user change input; and
automatically changing the content type mix of the displayed item of content based on the user change input.

2. The computer-implemented method of claim 1 wherein the displayed item of content includes text and an image, and wherein the content type mix comprises an image/text mix, the image/text mix defining an image display portion corresponding to a portion of the user interface display used to display the image and a text display portion corresponding to a portion of the user interface display used to display the text.

3. The computer-implemented method of claim 2 wherein displaying the user input mechanism comprises:
displaying a movable element, movable between a plurality of different positions on the user interface display, each of the plurality of different positions corresponding to a different image/text mix.

4. The computer-implemented method of claim 3 wherein displaying the movable element comprises:
displaying the movable element, movable among a plurality of discrete positions, each discrete position corresponding to a predefined image/text mix.

5. The computer-implemented method of claim 3 wherein displaying the movable element comprises:
displaying the movable element, continuously movable along an axis, each position along the axis representing a different image/text mix.

6. The computer-implemented method of claim 3 wherein displaying a movable element comprises:
displaying a slider user input mechanism, actuatable to move between the plurality of different positions.

7. The computer-implemented method of claim 3 wherein a first of the plurality of different positions corresponds to a first image/text mix in which images are hidden; and
wherein automatically changing comprises:
in response to movement of the movable element to the first position, automatically reflowing the text in the displayed item of content to hide images in the displayed item of content.

8. The computer-implemented method of claim 7 wherein automatically reflowing the text comprises:
replacing each image in the displayed item of content with a corresponding actuatable element, actuatable to view the corresponding image.

9. The computer-implemented method of claim 3 wherein a second of the plurality of different positions corresponds to a second image/text mix in which text is hidden;
and wherein automatically changing comprises:
in response to movement of the movable element to the second position, automatically hiding the text in the displayed item of content to display images in the displayed item of content.

10. The computer-implemented method of claim 9 wherein automatically hiding the text comprises:
replacing each section of text in the displayed item of content with a corresponding actuatable element, actuatable to view the corresponding section of text.

11. The computer-implemented method of claim 3 wherein displaying the movable element comprises:
displaying the movable element on a touch sensitive display screen, the movable element being movable with a touch gesture on the touch sensitive display screen.

12. A computer-implemented method of generating a presentation of an item of content from a content collection, the method comprising:
displaying the item of content on a user interface display according to a detail level, the detail level defining a level of displayed detail in the displayed item of content;
receiving a user input on the user interface display indicative of a user change input; and
automatically changing the detail level of the displayed item of content based on the user change input.

13. The computer-implemented method of claim 12 wherein receiving the user change input comprises:
displaying a movable element, movable between a plurality of different positions on the user interface display, each of the plurality of different positions corresponding to a different detail level.

14. The computer-implemented method of claim 13 wherein displaying the movable element comprises:
displaying the movable element, movable among a plurality of discrete positions, each discrete position corresponding to a predefined detail level.

15. The computer-implemented method of claim 13 wherein displaying the movable element comprises:
displaying the movable element, continuously movable along an axis, each position along the axis representing a different detail level.

16. The computer-implemented method of claim 13 wherein displaying a movable element comprises:
displaying a slider user input mechanism, actuatable to move between the plurality of different positions.

17. The computer-implemented method of claim 12 wherein a first detail level corresponds to a summary detail level and wherein automatically changing the detail level comprises:
in response to the change input indicating the summary detail level, replacing the displayed item of content with a summary of the displayed item of content.

18. The computer-implemented method of claim 17 wherein a second detail level corresponds to a definition detail level and wherein automatically changing the detail level comprises:
in response to the change input indicating the definition detail level, adding, proximate a term in the displayed item of content, a definition of the term in the displayed item of content.

19. The computer-implemented method of claim 18 wherein the user interface display is displayed on a touch sensitive screen and wherein receiving the user change input comprises:
receiving one of a spread touch gesture and a pinch touch gesture on the user interface display as the user input to indicate a change in detail level from a current detail level toward the definition detail level; and
receiving another of the spread touch gesture and the pinch touch gesture on the user interface display as the user input to indicate a change in detail level from a current position toward the summary detail level.

20. A computer readable storage medium storing computer executable instructions which, when executed by a computer cause the computer to perform a method, comprising:
accessing a user's collection of reading material to obtain an item of content to be displayed, the item of content including text and an image;
accessing formatting data indicative of a format for displaying the item of content;
displaying the item of content on a user interface display based on the formatting data;
receiving a user input on the user interface display indicative of a user change input; and
automatically reflowing the text to change the display of the displayed item of content based on the user change input.
